(19) United States
(12) Patent Application Publication
(10) Pub. No.: US 2026/0332624 A1
(43) Pub. Date: Oct. 22, 2026

(54) SYSTEM

(71) Applicant: SoftBank Group Corp., Tokyo (JP)

(72) Inventor: Rion MANABE, Tokyo (JP)

(73) Assignee: SoftBank Group Corp., Tokyo (JP)

(21) Appl. No.: 19/647,948

(22) Filed: Apr. 15, 2026

(30) Foreign Application Priority Data
Apr. 22, 2025 (JP) 2025-070267

(51) Int. Cl. H04L 9/40

(52) U.S. Cl. CPC H04L 63/1425; H04L 63/1416

(57) ABSTRACT

The present invention relates to a system that highly automates operation management of an entire IT infrastructure, comprises a system management unit, a security monitoring unit, and a resource optimization unit, analyzes an operating status, load information, failure occurrence, access logs, authentication histories, external threat information, and the like of a plurality of information processing apparatuses and network devices in real time using generative AI, and centrally and highly accurately executes abnormality detection, failure cause estimation, threat detection, automatic response, resource allocation optimization, cost reduction proposals, and the like. Thereby, it is characterized by realizing integrated management, security enhancement, operational efficiency improvement, and business continuity improvement of a complex IT infrastructure, which have conventionally been difficult.

### CROSS-REFERENCE TO RELATED APPLICATION

The present application claims priority to and incorporates by reference the entire contents of Japanese Patent Application No. 2025-070267 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that, in the management work of complex and diverse information systems in an IT department, it has conventionally been difficult to centrally and efficiently perform operations such as monitoring, operation, failure response, resource optimization, and security measures, which were distributed for each individual system, and in particular, it has been difficult to grasp the operating status and load status of the entire system in real time, perform early discovery of and rapid response to an abnormality or a failure, further detect highly sophisticated and ingenious security risks such as cyber attacks and internal frauds with high accuracy, automatically and immediately execute an appropriate response without depending on human resources, and further continuously analyze the resource usage status of the entire IT infrastructure, and autonomously plan and execute optimal resource allocation and configuration change according to a work load and future demand fluctuation while eliminating excessive resource consumption and waste. In addition, if an attempt is made to realize these operations only by conventional manual work or rule-based automation, problems such as an enormous operational load, dependence on personalized know-how, limits on the accuracy and speed of abnormality detection and threat response, and a lack of flexibility in resource optimization have occurred. Therefore, an object of the present invention is to highly automate monitoring, analysis, optimization, and security response of the entire IT infrastructure utilizing generative AI, and dramatically improve the operational efficiency, safety, and flexibility of the IT department.

### SUMMARY OF THE INVENTION

Means for solving the problem according to the present invention configures a system comprising a system management unit, a security monitoring unit, and a resource optimization unit, wherein the system management unit is configured to collect an operating status and load information of an entire IT infrastructure including a plurality of information processing apparatuses and network devices in real time, analyze the operating status of each device and presence or absence of an occurrence of an abnormality using generative AI, and immediately generate alert information and notify an administrator terminal of the alert information when an abnormality or a high load is detected, thereby enabling centralized monitoring of the entire system and early discovery of and response to a failure.

Further, the security monitoring unit is configured to analyze access logs and communication data to the IT infrastructure using generative AI, detect threats such as unauthorized access from outside and inside and malware infection with high accuracy, automatically execute response processing such as access blocking and isolation for the detected threats, and record a response history thereof, thereby realizing immediate responsiveness to and automation for security risks. Furthermore, the resource optimization unit is configured to analyze a resource usage status of each information processing apparatus using generative AI, automatically execute scaling of a virtual server or a storage capacity when a load is high, propose or automatically execute reduction or suspension of resources when the load is low, and present these optimization proposals and execution results to the administrator terminal, thereby making it possible to significantly improve resource operational efficiency and flexibility of the entire IT infrastructure.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

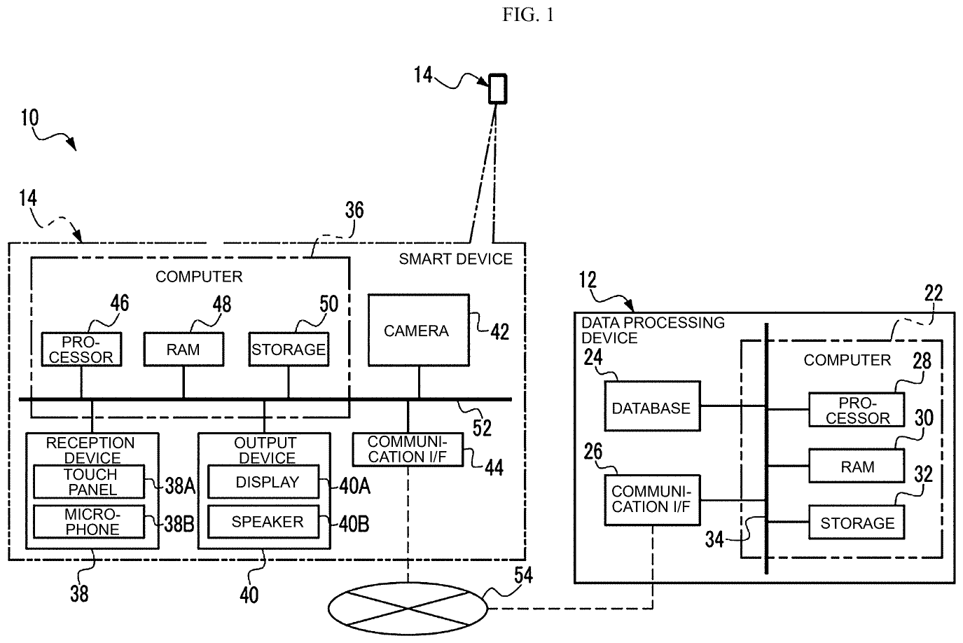

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

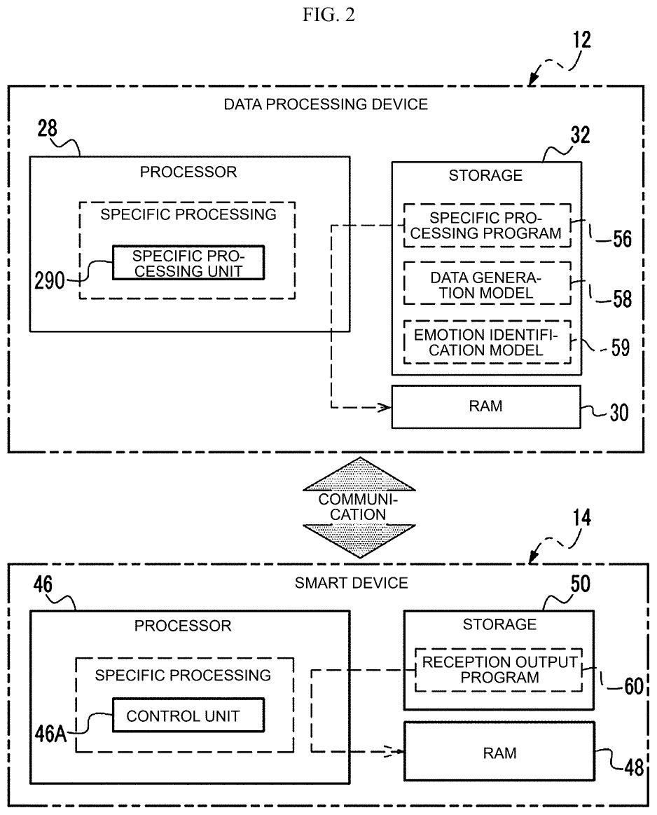

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described more specifically and in detail. The present invention is applied to an IT infrastructure management system composed of a server and a terminal, and is configured such that main functions of a system management unit, a security monitoring unit, and a resource optimization unit are implemented on the server side, and an interface for an administrator to operate and browse is implemented on the terminal side. Hereinafter, functions of each unit, a method of utilizing generative AI, role sharing between the server and the terminal, and specific operation examples will be comprehensively and detailedly described. Specifically, the present system executes dynamic allocation and monitoring of hardware resources in a distributed computing environment. The server includes a plurality of compute nodes and a large-capacity storage device. The server deploys a plurality of neural networks including a large language model and a time-series prediction model on a main memory. The system management unit continuously collects time-series metrics data from each information processing apparatus. The security monitoring unit analyzes a packet header and a payload of network traffic in real time. The resource optimization unit predicts a future calculation load based on the collected metrics data. The present system executes these processes at high speed by a parallel computing cluster using graphics processing units. The present system realizes autonomous infrastructure control without human intervention. The present system extracts a non-linear correlation in a high-dimensional space, which was impossible with conventional rule-based threshold determination. The present system thereby dramatically reduces a false positive rate. The present system is applied to use cases such as operation management of a data center and automatic control of a large-scale cloud infrastructure. The present system brings about a technical effect of improving operating efficiency of hardware. The present system suppresses wasteful consumption of a communication band. The present system minimizes a standby time of a processor. The present system advances computer technology itself by these technical improvements. The present system optimizes physical resource management inside a computer, rather than mere business efficiency improvement. The present system shares tensor data among a plurality of modules. The present system performs inter-process communication via a shared memory space. The present system thereby reduces communication overhead among the modules. The present system minimizes overall processing delay in milliseconds.

First, the system management unit is implemented on the server, and collects a wide variety of data in real time, such as an operating status, usage rates of a CPU, a memory, a disk, and a network, an operating process, a response time of a service, failure occurrence information, an event log, a system log, an application log, a job execution history, and a configuration change history, from various information processing apparatuses constituting the IT infrastructure, such as a physical server, a virtual server, a network device, a storage device, a cloud service, a business application, a database, a backup device, a load balancer, a firewall, and a VPN device. For example, information is acquired by combining a plurality of means such as SNMP, Syslog, an API, agent software, and a cloud monitoring service. These data are analyzed by the generative AI using advanced algorithms such as time-series analysis, abnormality detection, clustering, pattern mining, and causal inference. For example, complex abnormality patterns that are difficult to detect by conventional threshold determination or a simple rule base, such as a sudden increase in CPU usage rate, a gradual increase in usage rate due to a memory leak, a disk I/O bottleneck, occurrence of network delay, runaway of a specific process, and intermittent response delay of a service, are also detected with high accuracy. The generative AI learns, for example, past failure cases, operation histories, system configuration information, and external failure databases, and automatically estimates a cause of occurrence of an abnormality and an affected range. For example, specific alert contents and a recommended countermeasure, such as “Since the CPU load of the virtual server J is similar to a past failure pattern, a memory leak of the application K is suspected” and “A sudden increase in traffic of the network device L is estimated to be caused by a setting error of a backup job”, are generated in natural language and notified to the administrator terminal. Furthermore, even in a system configuration spanning a plurality of bases, an environment where cloud and on-premises are mixed, or an environment where devices from a plurality of vendors are mixed, for example, the generative AI can analyze an overall correlation and visualize a failure ripple risk, a dependency relationship, effectiveness of a redundant configuration, a failover status at the time of a failure, and the like. For example, the soundness of the entire system is evaluated from multiple angles, such as “There is a high risk that a network failure at base A will ripple to a business system at base B” and “Automatic switching to on-premises N operated normally at the time of a failure of cloud service M”. Specifically, the system management unit acquires thousands of log entries and performance metrics per second from each information processing apparatus via a data collection agent. The system management unit converts the acquired raw data into a multidimensional numerical tensor. The system management unit normalizes time-series data such as a processor usage rate and a memory usage amount so as to have zero mean and unit variance, for example. The system management unit configures the normalized data as a 512-dimensional input vector. The system management unit inputs this input vector to a transformer-based neural network equipped with a self-attention mechanism. The neural network calculates a hidden state vector from the input time-series data. The neural network calculates an abnormality score using a weight parameter learned from past failure patterns. A specific example of input data to the neural network includes a floating-point array indicating a transition of the processor usage rate over the past 24 hours. Another specific example of input data includes a time-series vector indicating a memory consumption amount of a specific process. A specific example of output data from the neural network includes an abnormality probability score ranging from zero to one. Another specific example of output data includes an attention weight matrix indicating a cause location of the abnormality. The system management unit activates subsequent diagnostic processing when the output abnormality probability score exceeds a predetermined threshold. The system management unit inputs the abnormality score and the attention weight matrix to a large language model. The large language model generates a diagnostic text in natural language by combining the input numerical data and metadata of the system configuration. The large language model is a deep learning model having billions of parameters. The large language model is pre-trained using a cross-entropy loss function. The large language model is fine-tuned using an operation log unique to the system. The system management unit transmits the generated diagnostic text to the administrator terminal. The system management unit further identifies a process that caused the abnormality. The system management unit automatically issues a termination command to the identified process. The present system discovers a sign of a minute abnormality exceeding human cognitive limits at an early stage by such a tensor operation in a high-dimensional space. The present system thereby exhibits a technical effect of preventing system downtime. The present system is extremely effective in use cases such as infrastructure monitoring of an accounting system of a financial institution or an e-commerce platform. The present system fundamentally improves conventional simple threshold monitoring. The present system realizes an autonomous self-healing function of a computer. The present system adopts a continuous learning algorithm in order to improve accuracy of abnormality detection. The present system dynamically updates weights of the neural network using newly collected data. The present system thereby has an adaptive capability even for an unknown failure pattern.

Next, the security monitoring unit is also implemented on the server, and collects and accumulates an access log, communication data, an authentication history, a file operation history, an application log, a system log, threat intelligence information from the outside, a detection log of an IDS/IPS, a detection log of endpoint antivirus software, and the like of the entire IT infrastructure in real time. The generative AI detects, with high accuracy, a pattern different from normal business access, such as a large amount of access in a late-night time zone, a plurality of authentication failures in a short time, a connection from an unknown IP address, taking out of a large amount of files by an internal user, command and control communication by malware, a sign of ransomware, spread of a phishing email, and suspicious behavior of an IoT device, using, for example, natural language processing, an abnormality detection algorithm, graph analysis, behavior analysis, and a classification/regression model by machine learning. Furthermore, the generative AI can learn, for example, past attack methods, latest threat intelligence, external security information sharing services, and attack information on the dark web, and can also detect a sign of an unknown attack or a zero-day attack at an early stage. When a threat is detected, the generative AI automatically generates and immediately executes response procedures such as access blocking, isolation of a corresponding terminal, saving of a log, notification to related parties, acquisition of forensic data, identification of an affected range, visualization of an attack route, and proposal of a damage expansion prevention measure. For example, when suspicious communication from the outside is detected, a corresponding firewall rule is automatically generated and applied, and a detailed response history such as “A port scan to the network device P was detected, and communication from the corresponding IP address was blocked” and “Behavior of ransomware was detected in the server Q, the corresponding terminal was isolated from the network, and a backup of an encrypted file was acquired” is presented to the administrator terminal in natural language. Furthermore, when a sign of internal fraud is detected, for example, human risks are also immediately responded to, such as “Since user R transferred a large amount of files to an external storage outside normal business hours, the account was temporarily suspended and a detailed investigation was started”. Specifically, the security monitoring unit acquires packet data from a mirror port of a network switch. The security monitoring unit extracts header information and a payload of the acquired packet. The security monitoring unit encodes the extracted information into a fixed-length numerical vector. The security monitoring unit inputs this numerical vector to a convolutional neural network and a graph neural network. A specific example of input data to the neural network includes a vector obtained by one-hot encoding a source Internet Protocol address and a destination port number. Another specific example of input data includes a multidimensional tensor obtained by normalizing a byte sequence of the payload. The neural network executes a convolution operation and a pooling operation on the input tensor. The neural network learns a relationship between nodes using an adjacency matrix reflecting a network topology. A specific example of output data from the neural network includes a threat score indicating a probability that each packet is malware communication. Another specific example of output data includes a categorical distribution indicating a type of attack. The security monitoring unit determines whether or not the output threat score falls below a safety reference value. The security monitoring unit immediately executes subsequent defense processing when the threat score is high. The security monitoring unit dynamically generates an access control list for blocking a corresponding communication flow. The security monitoring unit applies this access control list to a firewall device. The security monitoring unit further generates a text explaining an outline of an incident using a large language model. The large language model receives the threat score and an attack category as inputs. The large language model outputs a report in natural language that is easy for an administrator to understand. The present system completes these processes with a latency in milliseconds. The present system realizes autonomous defense without waiting for manual analysis by a human security analyst. The present system thereby brings about a technical effect of physically preventing expansion of damage caused by a cyberattack. The present system is applied to use cases of protecting a confidential network of a government agency or a core information system of a company. The present system identifies a zero-day attack, which cannot be handled by a conventional signature-based intrusion detection system, as an unknown pattern in a high-dimensional space. The present system fundamentally improves robustness of a computer network. The present system integrates outputs of a plurality of neural networks by ensemble learning in order to reduce false positives. The present system thereby achieves extremely high detection accuracy.

The resource optimization unit is also implemented on the server, and continuously collects and analyzes a resource usage status of the entire IT infrastructure, for example, usage rates of a CPU, a memory, a storage, and a network band, an operating status of a virtual machine, a load balancing status for each application, an execution plan of a job scheduler, a business calendar, event information, seasonal fluctuation, a cooperation status with an external system, and the like. The generative AI learns various data such as a past usage history, a business calendar, event information, and seasonal fluctuation using, for example, time-series prediction, demand prediction, abnormality detection, an optimization algorithm, and reinforcement learning, and predicts a future load fluctuation. For example, dynamic scaling is automatically executed, such as grasping a tendency that use of a business system concentrates at the end of a month or the end of a fiscal year and automatically adding a virtual server in advance, or reducing resources in a time zone with little use such as nighttime or a holiday. Furthermore, when a specific application temporarily has a high load, for example, the generative AI proposes or automatically executes optimal resource allocation, such as load balancing to another server, automatic expansion of a storage capacity, priority control of a network band, scheduling change of a backup job, live migration of a virtual machine, and automatic procurement of cloud resources. For example, various proposals considering cost optimization and business continuity are made, such as “Resources of virtual server S are scheduled to be automatically enhanced from 18:00 today”, “Automatic expansion was executed because free capacity of storage T decreased”, “Backup job is automatically moved to late-night time zone because network band is tight”, and “Workload migration to on-premises V is proposed because usage fee of cloud service U is soaring”. These optimization proposals and execution results are presented to the administrator terminal in natural language in a specific and easy-to-understand form through various interfaces such as a dashboard, a report, an alert notification, and a chatbot. Specifically, the resource optimization unit collects time-series data indicating a processor usage rate and a memory allocation amount of each virtual machine. The resource optimization unit inputs this time-series data to a long short-term memory network or a transformer model. A specific example of input data to the neural network includes a three-dimensional tensor indicating a resource consumption amount over the past week. Another specific example of input data includes a vector obtained by encoding calendar information indicating a day of the week and a time zone. The neural network predicts a future load fluctuation from these input data. A specific example of output data from the neural network includes an array of predicted processor usage rates in each time zone for the next 24 hours. Another specific example of output data includes an integer value indicating the number of necessary virtual machines. The resource optimization unit inputs this prediction result to a reinforcement learning agent. The reinforcement learning agent searches a state space and an action space based on a Markov decision process. The reinforcement learning agent is learned using a reward function that minimizes a penalty due to excess or deficiency of resources and an infrastructure cost. A specific example of output data from the reinforcement learning agent includes a migration command for moving a specific virtual machine to another physical server. Another specific example of output data includes a provisioning instruction for expanding a capacity of a storage volume. The resource optimization unit determines optimal resource allocation based on this output action value function. The resource optimization unit executes the determined allocation plan via an application programming interface of a hypervisor. The present system thereby exhibits a technical effect of maximizing utilization efficiency of hardware resources. The present system reduces power consumption and optimizes an operation cost of a data center. The present system is applied to a use case of responding to a sudden traffic increase during a sale period of an e-commerce site. The present system eliminates manual setting based on a rule of thumb by a human administrator. The present system improves throughput of the entire computer system by combining a high-dimensional prediction model and an optimization algorithm. The present system further generates a text explaining a basis for optimization using a large language model. The present system draws this text on a display of the administrator terminal.

The terminal side includes an interface for an administrator to operate and browse, and receives and displays, in real time, an alert, a threat detection result, a resource optimization proposal, an execution history, a failure response history, a security incident report, a resource usage prediction, a cost analysis report, a system configuration diagram, a dependency map, a failure ripple simulation result, and the like generated on the server side. For example, an operating status of the entire system is graphically displayed on a dashboard screen, and when an alert occurs, it is immediately transmitted to the administrator by various methods such as a pop-up notification, an email notification, a chat notification, and a push notification to a smartphone. Furthermore, the administrator can perform, from the terminal to the server, for example, approval/rejection of an optimization proposal, an additional response instruction, a request for a detailed report, prioritization of a failure response, escalation of a security incident, manual adjustment of resource allocation, a re-learning instruction for an AI model, and a cooperation setting with an external system, and bidirectional interaction is possible. Specifically, the terminal is an information processing apparatus equipped with a graphics processing unit. The terminal executes a web browser or a dedicated client application. The terminal establishes a persistent connection using a WebSocket protocol with the server. The terminal asynchronously receives a data stream in JSON format transmitted from the server. The terminal binds the received data to a virtual document object model on a memory. The terminal executes redrawing of a screen at high speed using hardware acceleration of the graphics processing unit. A specific example of input data to the terminal includes numerical data indicating importance of an alert transmitted from the server. Another specific example of input data includes array data of nodes and edges indicating a topology of a system configuration. The terminal dynamically generates a graph or a chart on the dashboard based on these input data. A specific example of output data from the terminal includes a Boolean value of an approval flag generated when the administrator clicks a button on the screen. Another specific example of output data includes a query character string in natural language input by the administrator. The terminal transmits these output data to the server. The server receives this data and activates a subsequent processing pipeline. The present system thereby realizes seamless cooperation between the administrator and an autonomous control system. The present system brings about a technical effect of improving visibility of information. The present system reduces a cognitive load on the administrator and supports quick decision-making. The present system is applied to a use case such as a monitoring task in a large-scale network operation center. The present system visually expresses a semantic relationship of data, rather than a mere enumeration of information. The present system improves operability by minimizing drawing delay of a user interface. The present system distributes a load on the server side by effectively utilizing calculation resources on the terminal side.

In addition, utilization of generative AI is the core of the present invention, and for example, for learning of an abnormality detection model, various data such as a past failure log, an operation history, security incident information, external threat intelligence, a business calendar, event information, system configuration information, a user behavior history, and external environment data (weather, disaster information, social events, etc.) are used, and by continuously updating the model, it is possible to flexibly respond to environmental changes and new threats. For example, when an unknown attack method is discovered, it is also possible to automatically take in external threat intelligence information and strengthen the AI model. Furthermore, by utilizing a natural language generation function and automatically generating notifications and reports to the administrator, proposal contents, failure response procedures, explanation of circumstances of a security incident, explanation of a basis for resource optimization, simulation results of a cost reduction effect, and the like in an easy-to-understand manner, even a person in charge without specialized knowledge can easily grasp a situation and make a decision. Specifically, the present system implements a continuous learning pipeline of a generative artificial intelligence model. The present system accumulates newly collected log data and incident reports as a learning dataset. The present system periodically updates weight parameters of a neural network using this dataset. The present system uses an optimization algorithm such as stochastic gradient descent or adaptive moment estimation. The present system calculates a cross-entropy error or a mean squared error as a loss function during learning. A specific example of input data to the neural network includes a byte array indicating a signature of newly discovered malware. Another specific example of input data includes a sequence of text tokens indicating a configuration change history of the system. A specific example of output data from the neural network includes a tensor of billions of updated weight parameters. Another specific example of output data includes a transition graph of a loss value indicating a convergence state of learning. The present system dynamically deploys the updated model to an inference engine. The present system thereby exhibits a technical effect of continuously improving inference accuracy of the model. The present system strengthens an adaptive capability of the system to secular changes in an environment and new cyber threats. The present system is applied to a use case such as automatic operation in an environment of continuous integration and continuous delivery of a cloud infrastructure. The present system adopts a beam search algorithm or top-p sampling in a decoding process of a large language model. The present system thereby generates an explanatory text that is contextually natural and technically accurate. The present system passes the generated text to a subsequent notification module. The present system push-delivers information to the terminal of the administrator via the notification module. The present system formalizes tacit knowledge possessed by a human expert as weights of a neural network. The present system realizes automatic inheritance of knowledge using computer technology.

For example, the system management unit automatically diagnoses that “Since the memory usage rate of the server W has rapidly increased in the past 24 hours and matches a past failure pattern, a leak of the process X is suspected”, the security monitoring unit immediately responds that “A brute force attack on the network device Y was detected, and the corresponding IP address was automatically blocked”, and the resource optimization unit proposes that “Since the usage rate of the virtual server Z is low, automatic suspension is proposed at night” and “Workload migration to on-premises BB is proposed because the cost of the cloud service AA is soaring”, and each unit cooperates to realize advanced autonomous operation. Furthermore, for example, when a failure occurs, the AI automatically identifies an affected range of the failure, generates a dependency map and presents it to the administrator, and automatically generates a failure response procedure and distributes it to related parties. When a security incident occurs, the AI automatically visualizes an attack route, immediately executes a damage expansion prevention measure, and automatically generates an incident report and submits it to management. At the time of resource optimization, the AI predicts a future business load, automatically generates an optimal resource allocation plan, simulates a cost reduction effect and an impact on business continuity, and presents them to the administrator. Specifically, the present system adopts a multi-agent architecture in which a plurality of autonomous agents operate in cooperation. The system management unit agent analyzes a time-series tensor of a memory usage rate. The system management unit agent writes a state flag in a shared memory space when detecting an abnormality. The security monitoring unit agent monitors this state flag. The security monitoring unit agent analyzes a packet header of network traffic and identifies unauthorized access. The security monitoring unit agent adds the identified Internet Protocol address to a blocking list. The resource optimization unit agent inputs a load fluctuation due to these incident responses to a prediction model. A specific example of input data to the prediction model includes a multidimensional vector of a system state collected from each agent. Another specific example of input data includes numerical data indicating a progress rate of batch processing currently being executed. A specific example of output data from the prediction model includes a probability distribution indicating a future load of each physical server. Another specific example of output data includes a clustering result indicating optimal arrangement of virtual machines. The present system integrates these output results to generate an overall optimization command. The present system issues this command to each hardware component. The present system thereby brings about a technical effect of achieving global optimization of the entire system rather than local optimization. The present system prevents a cascade failure in which a plurality of failures occur in a chain reaction. The present system is applied to a use case such as infrastructure operation of a web application adopting a large-scale microservice architecture. The present system uses a message queuing protocol in order to minimize communication overhead among respective modules. The present system enhances parallelism of processing by asynchronous messaging. The present system dramatically improves fault tolerance of a computer system.

As described above, in the embodiment of the present invention, by implementing the system management unit, the security monitoring unit, and the resource optimization unit utilizing generative AI on the server side, and implementing the administrator interface on the terminal side, it is possible to comprehensively solve various and complex problems such as unified and advanced automatic operation of the entire IT infrastructure, security enhancement, resource optimization, cost reduction, business continuity improvement, failure response speeding up, human risk reduction, automatic inheritance of operation know-how, and flexible response to external environment changes. Specifically, the present system constructs a cyber-physical system in which hardware and software closely cooperate. The present system processes a huge amount of sensor data collected from each information processing apparatus in real time. The present system breaks through limits of conventional heuristic methods by high-dimensional data analysis using a deep learning model. The present system maximizes computing capability of a processor and a large-capacity memory. The present system offloads inference processing of a neural network to a dedicated tensor processing unit. The present system thereby exhibits a technical effect of significantly shortening inference latency. The present system dynamically controls power consumption of the entire data center. The present system improves physical energy efficiency by optimizing an operating rate of a cooling device. The present system is applied to mission-critical use cases such as infrastructure management of a smart city and core network control of a large-scale communication carrier. The present system maximizes operation efficiency of a computer architecture itself, rather than mere automation of a business process. The present system embodies a concept of a self-organizing network. The present system autonomously constructs a detour route even for an unknown hardware failure or a software bug. The present system maintains availability of the system at a level of nines. The present system provides a next-generation autonomous computing infrastructure by these technical features.

### System Configuration

The system according to the present embodiment includes a system management unit, a security monitoring unit, a resource optimization unit, a data collection unit, a user interface unit, an AI learning/inference unit, and a notification/report generation unit. The system management unit collects a wide variety of data in real time, such as an operating status, usage rates of a CPU, a memory, a disk, and a network, an operating process, a response time of a service, failure occurrence information, an event log, a system log, an application log, a job execution history, and a configuration change history, from various information processing apparatuses such as a physical server, a virtual server, a network device, a storage device, a cloud service, a business application, a database, a backup device, a load balancer, a firewall, and a VPN device, acquires information by combining a plurality of means such as SNMP, Syslog, an API, agent software, and a cloud monitoring service, for example, and performs preprocessing, normalization, correction of an abnormal value, shaping of time-series data, and the like for inputting these data to generative AI. The system management unit generates a prompt sentence such as “Analyze time-series data of CPU, memory, and disk usage rates of a server group for the past 24 hours, and explain an abnormal tendency and a sign of a failure in natural language” and “Extract a pattern different from normal times from a traffic log of a network device, and estimate a cause” to the generative AI, and instructs the AI to perform analysis. For example, when the CPU usage rate of a virtual server rapidly increases, the system management unit generates a prompt such as “The CPU usage rate of server A has exceeded 90 percent since 13:00 today. Collate with past failure patterns and output a cause and a recommended countermeasure”, and executes diagnosis by the AI. Furthermore, even in a system configuration spanning a plurality of bases or an environment where cloud and on-premises are mixed, a prompt such as “Estimate an impact of a network failure at base X on a business system at another base, and generate a dependency map” is used in order to cause the AI to analyze a dependency relationship and a failure ripple risk. Specifically, the present system integrally analyzes a system log and metrics data using natural language processing technology. The system management unit cleanses the collected raw data and complements a missing value. The system management unit embeds this preprocessed data into a prompt template in text format. The system management unit inputs this prompt to a tokenizer and converts it into an array of integer token identifiers. The system management unit inputs this token array to an embedding layer of a large language model. A specific example of input data to the large language model includes thousands of token identifiers obtained by dividing a character string of a system log. Another specific example of input data includes a numerical token obtained by converting time-series metrics into a text expression. The large language model calculates a contextual dependency relationship between tokens using a self-attention mechanism of a transformer architecture. A specific example of output data from the large language model includes a logit vector indicating a probability distribution of a next following word. Another specific example of output data includes a text character string of a generated diagnostic result. The system management unit inputs this output text to a syntax analyzer. The system management unit extracts a specific action command and an identifier of a target node from the text. The system management unit executes a subsequent automatic recovery script based on this extracted information. The present system thereby brings about a technical effect of processing a log message, which is unstructured data, and metrics, which are structured data, in the same latent space. The present system identifies a root cause of a complex failure that has been overlooked by a conventional rule-based log monitoring tool. The present system is applied to a use case such as troubleshooting of a distributed system in a multi-cloud environment. The present system optimizes inference accuracy of a model using a prompt engineering method. The present system dramatically improves a self-diagnostic capability of a computer.

The security monitoring unit collects and accumulates an access log, communication data, an authentication history, a file operation history, an application log, threat intelligence information from the outside, a detection log of an IDS/IPS, a detection log of endpoint antivirus software, and the like of the entire IT infrastructure in real time, generates prompt sentences for generative AI, such as “analyze the access log and the authentication history from 0:00 today to the present, extract an access pattern different from normal and suspicious behavior, and evaluate a threat level,” “detect signs of malware infection and command control communication from the communication data, and list corresponding terminals and communication destinations,” and “detect signs of a large amount of file taking-out by an internal user, and identify the corresponding user, a file name, and a transfer destination,” and executes multifaceted threat analysis by the AI. For example, when a large number of authentication failures occur late at night, the security monitoring unit generates a prompt such as “100 or more consecutive authentication failures by user B from 2:00 a.m. are recorded. Evaluate the possibility of a brute force attack and output a recommended countermeasure,” and performs immediate diagnosis and automatic generation of a countermeasure by the AI. Furthermore, by causing the AI to take in external threat intelligence information and utilizing a prompt such as “collate the latest ransomware attack method with the communication log of this system, and report the presence or absence of a similar pattern,” it flexibly responds to unknown attacks and zero-day threats. Specifically, the security monitoring unit receives a log stream in real time from a security information and event management system. The security monitoring unit extracts a feature amount from this log stream and constructs a context of natural language. The security monitoring unit inputs this context as a prompt to a large language model. A specific example of input data to the large language model includes text data in which authentication failure events in the past hour are arranged in chronological order. Another specific example of the input data includes data obtained by converting a hexadecimal dump of a suspicious payload into a character string. The large language model evaluates the input data using a pre-learned cybersecurity knowledge base. A specific example of output data from the large language model includes an integer score from zero to one hundred indicating the severity of a threat. Another specific example of the output data includes structured data in a JSON format describing a recommended defense action. The security monitoring unit parses this output JSON data. The security monitoring unit calls an application programming interface of a firewall based on a parsing result. The security monitoring unit dynamically blocks a malicious Internet protocol address. The system thereby exerts a technical effect of shortening a response speed to an unknown attack pattern to a millisecond unit. The system is applied to a use case of completely automating an incident response task of a security operations center. The system algorithmizes a threat hunting process manually performed by a human analyst. The system surpasses signature-based detection by pattern matching in a high-dimensional language space. The system establishes a self-defense mechanism of a computer network.

The resource optimization unit continuously collects and analyzes a resource usage status of the entire IT infrastructure, for example, usage rates of a CPU, a memory, a storage, and a network band, an operating status of a virtual machine, a load balancing status for each application, an execution plan of a job scheduler, a business calendar, event information, seasonal fluctuation, a cooperation status with an external system, and the like, generates prompt sentences for generative AI, such as “predict load fluctuation for the next one week based on a resource usage history for the past one month and the business calendar, and propose a plan for an increase or decrease in resources in natural language,” “simulate an optimal load balancing method when a high load occurs in a specific application, and output a recommended configuration,” “propose an automatic expansion procedure and a cost optimization measure when a storage capacity is tight,” and “evaluate the propriety and influence of migration to on-premises when a usage fee of a cloud service is soaring,” and performs an optimization proposal and automatic execution by the AI. For example, when the use of a business system is concentrated at the end of a month, the resource optimization unit generates a prompt such as “predict CPU and memory usage rates of a virtual server group for three days at the end of the month, and output the necessary number of additional servers and a scheduling plan,” and automatically generates a dynamic scaling plan by the AI. Furthermore, it utilizes prompts for instructing the AI on various optimization scenarios, such as reduction of resources at night or on holidays, optimal scheduling of a backup job, and workload migration between a cloud and on-premises. Specifically, the resource optimization unit acquires metadata indicating a resource allocation status from a management server of a virtualization infrastructure. The resource optimization unit combines this metadata and a past performance index to generate a multimodal prompt. The resource optimization unit inputs this prompt to a large language model. A specific example of input data to the large language model includes a list of key-value pairs indicating the number of processor cores and a memory capacity of each virtual machine. Another specific example of the input data includes a natural language text indicating a schedule of a future business event. The large language model integrates these input data to infer an optimal resource allocation plan. A specific example of output data from the large language model includes a numerical matrix indicating an increase or decrease amount of resources for each node. Another specific example of the output data includes an executable script code describing a migration procedure. The resource optimization unit transmits this output script code to an orchestration engine. The orchestration engine interprets the script and automatically executes live migration of a virtual machine or scale-out of a container. The system thereby brings about a technical effect of evolving the concept of infrastructure as code into a dynamic and autonomous process. The system prevents over-provisioning of resources in a cloud computing environment and minimizes costs. The system is applied to a use case such as auto-scaling against a rapid increase in traffic of a large-scale web service. The system realizes predictive scaling that understands a context, rather than scaling based on a static threshold. The system fundamentally improves the flexibility and elasticity of a computer system.

A data collection unit collects necessary data in real time or periodically from various information processing apparatuses, network devices, cloud services, business applications, external databases, threat intelligence services, and the like, performs data preprocessing, normalization, missing value complementation, abnormal value detection, format conversion, time-series shaping, metadata addition, and the like, and provides the data to an AI learning/inference unit and each unit. For example, the data collection unit supports various data sources, such as reception of an SNMP trap and a Syslog message, acquisition of cloud resource information by an API, collection of terminal information by agent software, automatic acquisition of external threat intelligence, and import of a business calendar and event information. Specifically, the data collection unit processes millions of event data per second using a distributed stream processing platform. The data collection unit temporarily buffers an asynchronous message transmitted from each device in a message queue. The data collection unit cuts out this buffered data with a certain window size and processes it as a mini-batch. The data collection unit complements data by applying a K-nearest neighbor method or a linear interpolation algorithm to a missing value. The data collection unit removes an outlier using Z-score determination or an isolation forest algorithm. A specific example of input data to the data collection unit includes packet capture data in a binary format transmitted from a network device. Another specific example of the input data includes an unstructured text log output from an application server. A specific example of output data from the data collection unit includes a multidimensional tensor of floating point directly inputtable to a machine learning model. Another specific example of the output data includes an array of normalized JSON objects with synchronized timestamps. The data collection unit stores this output data in an in-memory data grid or a time-series database. The system thereby exerts a technical effect of enabling a subsequent artificial intelligence model to perform inference with high-quality data with less noise. The system conceals a calculation overhead required for data preprocessing by distributed processing. The system is applied to a use case such as aggregation and preprocessing of a huge amount of sensor data in an Internet of Things environment. The system absorbs a difference in data format in a heterogeneous environment and constructs a unified data lake. The system maximizes the efficiency of a data processing pipeline of a computer.

A user interface unit operates on an administrator terminal, and receives and displays, in real time, an alert, a threat detection result, a resource optimization proposal, an execution history, a failure response history, a security incident report, a resource usage prediction, a cost analysis report, a system configuration diagram, a dependency map, a failure ripple simulation result, and the like generated on the server side. For example, an operating status of the entire system is graphically displayed on a dashboard screen, and when an alert occurs, it is immediately transmitted to an administrator by various methods such as a pop-up notification, an email notification, a chat notification, and a push notification to a smartphone. Furthermore, the administrator can perform, from the terminal to the server, approval/rejection of an optimization proposal, an additional response instruction, a request for a detailed report, prioritization of a failure response, escalation of a security incident, manual adjustment of resource allocation, a re-learning instruction for an AI model, a cooperation setting with an external system, and the like, and bidirectional interaction is possible. Specifically, the user interface unit is implemented as a single-page application. The user interface unit immediately detects a state change on the server side via a WebSocket. The user interface unit calculates a difference of a virtual document object model based on the received data. The user interface unit minimizes a rendering load by reflecting only this difference in actual screen drawing. A specific example of input data to the user interface unit includes a JSON payload indicating an update of a system state push-delivered from the server. Another specific example of the input data includes a report text in natural language generated by an artificial intelligence model. A specific example of output data from the user interface unit includes a key-value pair of a parameter selected by the administrator on the dashboard. Another specific example of the output data includes a call request of an application programming interface for triggering re-learning of a model. The user interface unit transmits this output data to the server using asynchronous communication. The system thereby brings about a technical effect of providing a highly real-time user experience while suppressing consumption of a network band. The system enables the administrator to intuitively grasp the system state and perform quick command input. The system is applied to a use case such as an operator console in a monitoring center of a mission-critical system. The system smoothly executes three-dimensional drawing of a complex network topology by utilizing hardware acceleration of a graphics processing unit. The system improves a human-computer interface technology.

The AI learning/inference unit operates on the server, and performs learning and inference of an abnormality detection model, a threat detection model, a resource optimization model, a natural language generation model, and the like using various data provided from the data collection unit. For example, it continuously updates the models using a past failure log, an operation history, security incident information, external threat intelligence, a business calendar, event information, system configuration information, a user behavior history, external environment data, and the like, and flexibly responds to an environmental change and a new threat. The AI learning/inference unit receives prompt sentences from the system management unit, the security monitoring unit, and the resource optimization unit, executes analysis, inference, and natural language generation, and returns a result to each unit. Specifically, the learning/inference unit is executed on a parallel computing cluster in which a plurality of graphics processing units are interconnected. The learning/inference unit constructs a calculation graph of a neural network using a deep learning framework. The learning/inference unit optimizes a weight parameter of the network using a backpropagation algorithm. The learning/inference unit incorporates a normalization layer and a residual connection into a network architecture in order to avoid a vanishing gradient problem. A specific example of input data to the learning/inference unit includes a mini-batch tensor including millions of log entries provided from the data collection unit. Another specific example of the input data includes a prompt character string of an inference request transmitted from each unit. A specific example of output data from the learning/inference unit includes an output vector of a softmax function indicating an affiliation probability of each class obtained as an inference result. Another specific example of the output data includes a generated text token sequence of natural language. The learning/inference unit returns this output data to a requesting module with a latency in a millisecond unit. The system thereby exerts a technical effect of efficiently executing learning and inference of a large-scale neural network on the same infrastructure. The system maximizes an inference throughput of a model and improves responsiveness of the system. The system is applied to a use case such as a real-time fraud detection system and a dynamic resource allocation engine. The system implements a scheduling algorithm for tensor calculation that utilizes a hardware computing unit to the utmost limit. The system optimizes a computing processing capability of a computer for an artificial intelligence task.

A notification/report generation unit automatically generates, in natural language, an alert notification for an administrator, a detailed report, an explanation of an incident background, an explanation of a basis for resource optimization, a simulation result of a cost reduction effect, a failure response procedure, an explanation of a background of a security incident, a dependency map, a failure ripple simulation result, and the like based on an output result of the AI learning/inference unit, and presents them to the administrator through the user interface unit. For example, it automatically generates a specific and easy-to-understand explanation, such as “a memory usage rate of server C has rapidly increased in the past 24 hours, and a leak of process D is suspected,” “a port scan to network device E was detected, and communication from a corresponding IP address was blocked,” “since a usage rate of virtual server F is low, automatic suspension at night is proposed,” and “since a cost of cloud service G is soaring, workload migration to on-premises H is proposed.” Specifically, the notification/report generation unit executes a natural language generation pipeline. The notification/report generation unit converts structured data received from the inference unit into a prompt for a text generation model. The notification/report generation unit executes a beam search decoding algorithm using this prompt to search for an optimal sequence of words. A specific example of input data to the notification/report generation unit includes a JSON object including an abnormality score output by an abnormality detection model and an identifier of a cause node. Another specific example of the input data includes a future predicted load tensor output by a resource optimization model. A specific example of output data from the notification/report generation unit includes a character string of an incident report formatted in a hypertext markup language. Another specific example of the output data includes a message payload in a markdown format transmitted to a webhook of a chat application. The notification/report generation unit transmits this output data to an external system via a simple mail transfer protocol or various application programming interfaces. The system thereby brings about a technical effect of converting an inorganic numerical value generated by a machine into context-rich information that a human can immediately understand. The system dramatically shortens an initial response time when an incident occurs. The system is applied to a use case such as automation of a help desk task in IT service management of a company. The system incorporates a fact-checking module into the pipeline in order to ensure the accuracy of the generated text. The system improves the quality of information transmission by a computer.

Specific examples of prompt sentences to be read by generative AI necessary for implementing the present invention include “analyze time-series data of CPU, memory, and disk usage rates of a server group, and explain an abnormal tendency and a sign of a failure in natural language,” “analyze an access log and an authentication history from 0:00 today to the present, extract an access pattern different from normal and suspicious behavior, and evaluate a threat level,” “predict load fluctuation for the next one week based on a resource usage history for the past one month and a business calendar, and propose a plan for an increase or decrease in resources in natural language,” “collate the latest ransomware attack method with a communication log of this system, and report the presence or absence of a similar pattern,” “a CPU usage rate of a virtual server has exceeded 90 percent since 13:00 today. Collate with a past failure pattern, and output a cause and a recommended countermeasure,” and “100 or more consecutive authentication failures by user B from 2:00 a.m. are recorded. Evaluate the possibility of a brute force attack, and output a recommended countermeasure.” Specifically, the system includes a template engine for dynamically constructing these prompt sentences. The system embeds a past similar case as a context in a prompt using a few-shot prompting method. The system thereby draws out an in-context learning capability of a large language model. A specific example of input data to the template engine includes an array of metrics variables indicating a current system state. Another specific example of the input data includes a text snippet of a past failure response history retrieved from a database. A specific example of output data from the template engine includes a complete prompt character string in which a variable is expanded and a context is complemented. The system processes this prompt character string with a tokenizer and inputs it to a model. The system parses an output result from the model using a regular expression or a syntax analyzer to extract an executable command. The system thereby exerts a technical effect of seamlessly combining an instruction in natural language and physical control of a computer. The system suppresses hallucination of the model and enhances the reliability of inference by optimizing the prompt. The system is applied to a use case such as automatic execution script generation of a complex system operation procedure. The system functions as an interface that accurately translates a human intention into an operation of a computer. The system incorporates prompt engineering as an automated process inside the system.

As described above, the system according to the present embodiment is configured such that each unit cooperates to collect, analyze, optimize, and notify various information, and comprehensively realizes unified and advanced automatic operation of the entire IT infrastructure, security enhancement, resource optimization, cost reduction, business continuity improvement, failure response speeding up, human risk reduction, automatic inheritance of operation know-how, flexible response to an external environmental change, and the like with generative AI at the core. Specifically, the system adopts an architecture in which each module operates independently as a microservice and cooperates asynchronously via a message broker. The system holds a state of the entire system as a huge multidimensional tensor on a memory. The system achieves global optimization by each artificial intelligence model sharing and updating this state tensor. The system makes each component redundant in order to eliminate a single point of failure, and maintains state consistency using a distributed consensus algorithm. The system thereby brings about a technical effect of realizing an autonomous infrastructure having extremely high scalability and fault tolerance. The system dynamically reconfigures a logical resource pool beyond a physical constraint of a data center. The system is applied to a use case such as a back-end infrastructure of a large-scale cloud service deployed globally. The system integrates conventional siloed operation management tools and provides a single intelligent control plane. The system solves a problem of system complication accompanying the evolution of computer technology by using a cognitive capability of artificial intelligence. The system executes total optimization beyond a boundary between hardware and software.

### Implementation Steps

### Step 1: Data Collection and Preprocessing

In this step, a wide variety of data, such as an operating status, usage rates of a CPU, a memory, a disk, and a network, an operating process, a response time of a service, failure occurrence information, an event log, a system log, an application log, a job execution history, a configuration change history, an access log, an authentication history, a file operation history, and external threat intelligence information, are collected in real time or periodically from various information processing apparatuses, such as a physical server, a virtual server, a network device, a storage device, a cloud service, a business application, a database, a backup device, a load balancer, a firewall, and a VPN device. The collected data is provided to the AI learning/inference unit and each unit through preprocessing such as missing value complementation, abnormal value detection, normalization, format conversion, time-series shaping, and metadata addition. Specifically, the system constructs a data pipeline and activates a stream processing engine. The system receives raw data via a transmission control protocol from an agent program installed in each information processing apparatus. The system writes the received raw data into an in-memory message queue. The system executes a worker process in parallel and reads data from the message queue. The system executes data type conversion and timestamp standardization on the read data. A specific example of input data to the system includes a log message in a JSON format asynchronously transmitted from each device. Another specific example of the input data includes a counter value in a binary format acquired by a simple network management protocol. A specific example of output data from the system includes a fixed-length numerical tensor matched with the number of dimensions of an input layer of a machine learning model. Another specific example of the output data includes matrix data obtained by converting a categorical variable into a one-hot vector. The system stores this output data in a feature amount store and passes it to a subsequent inference step. The system thereby exerts a technical effect of mapping non-uniform and noisy raw data to a high-quality feature amount space processable by artificial intelligence. The system suppresses a latency required for data preprocessing to a microsecond unit. The system is applied to a use case such as infrastructure monitoring of a high-frequency trading system and real-time unauthorized access detection. The system optimally utilizes a memory hierarchy of a computer to maximize a data throughput.

Step 2: System state monitoring and abnormality detection (utilization of generative AI) In this step, the system management unit causes the generative AI to analyze an operating status, a load status, and a sign of failure of the entire system using preprocessed data. Specific examples of prompt sentences to be read by the generative AI include “Analyze time-series data of CPU, memory, and disk usage rates of a server group for the past 24 hours, and explain abnormal tendencies and failure signs in natural language”, “Extract a pattern different from a normal time from a traffic log of a network device, and estimate a cause”, and “The CPU usage rate of a virtual server has exceeded 90 percent since 13:00 today. Collate with past failure patterns, and output a cause and a recommended countermeasure”. Based on these prompts, the AI performs detection of an abnormal pattern, estimation of a failure cause, and automatic generation of a recommended countermeasure. Specifically, the system inputs a preprocessed feature tensor into an inference pipeline. The system calls a large language model and a time-series abnormality detection model deployed on a memory of a graphics processing unit. The system feeds forward the feature tensor to an input layer of the model. The system executes matrix multiplication and calculation of a non-linear activation function in a hidden layer of the model in parallel. A specific example of input data to the model includes a multidimensional time-series matrix in which system metrics for the past several hours are combined. Another specific example of the input data includes an adjacency matrix expressing a topology graph of a system configuration. A specific example of output data from the model includes an array of floating points indicating a probability that each node is in an abnormal state. Another specific example of the output data includes a natural language text token sequence explaining a root cause of a failure. The system applies a softmax function to the output probability array to identify a most likely failure mode. The system activates an alert issuing module based on the identified failure mode. Thereby, the system brings about a technical effect of mathematically extracting a minute failure sign from a massive data stream that cannot be visually confirmed by a human operator. The system realizes proactive maintenance that prevents a complete stop of the system. The system is applied to a use case such as operation monitoring of a factory automation system in a large-scale manufacturing industry. The system improves reliability of a computer system using a pattern recognition technology in a high-dimensional space.

Step 3: Security threat detection and automatic response (utilization of generative AI) In this step, the security monitoring unit inputs an access log, communication data, an authentication history, a file operation history, an IDS/IPS log, external threat intelligence information, and the like into the generative AI, and executes threat detection and automatic response. Specific examples of prompt sentences to be read by the generative AI include “Analyze an access log and an authentication history from 0:00 today to the present, extract an access pattern different from normal and suspicious behavior, and evaluate a threat level”, “Detect signs of malware infection and command and control communication from communication data, and list corresponding terminals and communication destinations”, “Continuous authentication failures by user B from 2:00 midnight have been recorded 100 times or more. Evaluate a possibility of a brute-force attack, and output a recommended countermeasure”, and “Collate the latest ransomware attack method with a communication log of the system, and report presence or absence of a similar pattern”. Based on these prompts, the AI executes threat detection, identification of an attack route, estimation of a damage range, and automatic response such as immediate access blocking and terminal isolation. Specifically, the system executes a security orchestration automation response pipeline. The system inputs a feature vector extracted from network traffic into a threat detection model. The system generates a dynamic defense script based on an output result of the model. The system issues this script to a control interface of each security appliance. A specific example of input data to the model includes an embedded representation in which a payload of suspicious communication is vectorized by a natural language processing technology. Another specific example of the input data includes an event sequence in which user behavior histories are arranged in chronological order. A specific example of output data from the model includes a categorical distribution for classifying a malware family. Another specific example of the output data includes a command line character string for isolating an infected terminal. The system transmits and executes the output command line character string to a target switch or router via a secure shell protocol. Thereby, the system exhibits a technical effect of completing a lead time from detection of a cyber attack to defense in milliseconds without human intervention. The system prevents rapid spread of ransomware by physical network blocking. The system is applied to a use case such as real-time unauthorized remittance prevention in an online banking system of a financial institution. The system replaces conventional static signature matching with dynamic behavior analysis and an autonomous decision-making algorithm. The system functions as an autoimmune system of a computer network.

Step 4: Resource optimization and operation proposal (utilization of generative AI) In this step, the resource optimization unit inputs a resource usage status, a business calendar, event information, seasonal fluctuation, an external system cooperation status, and the like into the generative AI, and automatically generates optimal resource allocation and an operation proposal. Specific examples of prompt sentences to be read by the generative AI include “Predict load fluctuation for the next one week based on a resource usage history and a business calendar for the past one month, and propose a plan for an increase or decrease in resources in natural language”, “Simulate an optimal load balancing method when a high load occurs in a specific application, and output a recommended configuration”, “Propose an automatic expansion procedure and a cost optimization measure when a storage capacity is tight”, and “Evaluate propriety and impact of on-premises migration when a usage fee of a cloud service is soaring”. Based on these prompts, the AI automatically generates a dynamic scaling plan, a resource reduction plan, optimal scheduling of a backup job, a workload migration plan between cloud and on-premises, and the like. Specifically, the system drives a hybrid inference engine combining a large language model and a reinforcement learning agent. The resource optimization unit converts collected time-series data into a multidimensional tensor. The resource optimization unit generates an input tensor having a time step and a feature dimension. The resource optimization unit inputs this input tensor into an autoregressive neural network. The neural network predicts a future load from a past fluctuation pattern. The neural network outputs a prediction result as a probability distribution. The resource optimization unit maps this probability distribution to a prompt space of a natural language generation model. The natural language generation model analyzes the input context vector. The natural language generation model outputs a text token sequence including an optimal scaling factor and a migration procedure. The system parses this output text into structured data. The system transmits a control command to an orchestrator based on the parsed data. The orchestrator dynamically changes allocated resources of a virtual machine. By this processing, the system prevents excessive provisioning. The system maximizes utilization efficiency of computing resources. The system realizes a technical effect of reducing a cloud usage fee. The system executes data-driven infrastructure management that does not rely on human intuition. The system derives a solution satisfying a complex constraint condition by optimization calculation in a high-dimensional space.

Step 5: Notification/report generation and administrator interface cooperation In this step, based on an output result of an AI learning/inference unit, a notification/report generation unit automatically generates an alert notification for an administrator, a detailed report, an incident background explanation, a basis explanation for resource optimization, a simulation result of a cost reduction effect, a failure response procedure, a background explanation of a security incident, a dependency map, a failure ripple simulation result, and the like in natural language, and presents them to an administrator terminal in real time through a user interface unit. The administrator can perform approval/rejection of an optimization proposal, an additional response instruction, a request for a detailed report, prioritization of failure response, escalation of a security incident, manual adjustment of resource allocation, a retraining instruction for an AI model, a cooperation setting with an external system, and the like from the terminal, enabling bidirectional interaction. Specifically, the notification/report generation unit executes a natural language generation model based on a transformer architecture. The notification/report generation unit acquires an abnormality score and a resource prediction vector output from an inference engine. The notification/report generation unit converts these numerical data into a text embedding vector. The natural language generation model receives this text embedding vector as an input. The natural language generation model calculates a dependency relationship between data using a self-attention mechanism. The natural language generation model outputs a token sequence describing a root cause of an incident and a response procedure. The notification/report generation unit formats this token sequence into human-readable text data and structured data. The user interface unit renders this formatted data on a dashboard. The system receives an operation input of approval or rejection from the administrator. The system digitizes this operation input as a reward signal for reinforcement learning. The system fine-tunes a weight parameter of the natural language generation model using this reward signal. By this processing, the system continuously improves a report generation capability in line with the administrator's intention. The system significantly reduces a cognitive load on the administrator. The system accelerates a decision-making process when a failure occurs. The system realizes dynamic content generation according to a situation, rather than mere output of a boilerplate text.

### Specific Use Case

For example, assume a case where an entire IT infrastructure of a company spanning a plurality of bases is centrally managed. In this case, the system management unit collects a wide variety of data in real time, such as an operating status, usage rates of a CPU, a memory, a disk, and a network, an operating process, a response time of a service, failure occurrence information, an event log, a system log, an application log, a job execution history, and a configuration change history, from a physical server, a virtual server, a network device, a storage device, a cloud service, a business application, a database, a backup device, a load balancer, a firewall, a VPN device, and the like at each base. For example, when a phenomenon in which a CPU usage rate rapidly increases and network traffic also increases at the same time is observed in a virtual server group at a certain base, the system management unit inputs these data into the generative AI, and performs abnormality detection and cause estimation. Specific examples of prompt sentences to be read by the generative AI include “Analyze time-series data of a CPU usage rate and network traffic of a virtual server group, and explain abnormal tendencies and failure signs in natural language” and “Output a failure pattern and a recommended countermeasure for a server whose CPU usage rate has exceeded 90 percent since 13:00 today”. While referring to past failure cases and operation histories, the generative AI automatically generates a diagnosis result and a countermeasure such as “A simultaneous rapid increase in the CPU usage rate and the network traffic of virtual server A is estimated to be caused by resource contention due to a setting error of a backup job. A review of scheduling of the backup job is recommended”, for example, and notifies the administrator terminal. Specifically, the system management unit executes an analysis pipeline integrating a graph neural network and a time-series abnormality detection model. The system management unit converts the collected wide variety of data into a node feature matrix and an edge index. The system management unit generates graph structure data reflecting a network topology. The system management unit inputs this graph structure data into the graph neural network. The graph neural network propagates a feature vector between adjacent nodes. The graph neural network outputs a latent representation vector of each node. The system management unit inputs this latent representation vector into the time-series abnormality detection model. The time-series abnormality detection model calculates a reconstruction error. The time-series abnormality detection model outputs an abnormality score when the reconstruction error exceeds a predetermined threshold. The system management unit dynamically embeds this abnormality score and related metrics data into a prompt of a large language model. The large language model analyzes the input prompt. The large language model outputs text data indicating a root cause of a failure and a specific response procedure. The system transmits this text data to the administrator terminal. By this processing, the system accurately identifies a complex chain of failures in a distributed environment. The system prevents waste of a network band. The system dramatically shortens an average time to failure recovery. The system autonomously discovers an unknown failure pattern that cannot be detected by rule-based monitoring.

Also, in the security monitoring unit, for example, when a large number of authentication failures occur from a specific terminal at midnight and suspicious communication to the outside is observed at the same time, an access log, an authentication history, and communication data are input into the generative AI, and presence or absence of a threat, identification of an attack route, and estimation of a damage range are performed. Specific examples of prompt sentences to be read by the generative AI include “Analyze an access log and an authentication history from 0:00 today to the present, extract an access pattern different from normal and suspicious behavior, and evaluate a threat level” and “Analyze a relationship between continuous authentication failures from 2:00 midnight and external communication, and identify an attack route and a damage range”. The generative AI automatically generates a specific countermeasure such as “External communication occurring simultaneously with continuous authentication failures at midnight by user B is highly suspected to be a brute-force attack and malware infection. Network isolation of the corresponding terminal and temporary suspension of an account are recommended”, for example, and immediately executes automatic response processing. Specifically, the security monitoring unit drives a threat analysis engine combining a multilayer perceptron and a natural language processing model. The security monitoring unit converts an access log and communication data into a numerical vector. The security monitoring unit converts a categorical variable such as a time zone and an IP address into an embedding vector. The security monitoring unit combines these vectors to generate a high-dimensional feature vector. The security monitoring unit inputs this high-dimensional feature vector into the multilayer perceptron. The multilayer perceptron repeatedly executes non-linear transformation. The multilayer perceptron outputs a probability distribution belonging to each threat class. The security monitoring unit identifies a threat class having the highest value among this probability distribution. The security monitoring unit inputs this identification result and original log data into the natural language processing model. The natural language processing model understands a context of an attack. The natural language processing model outputs a structured text describing transition of an attack route and a recommended defense action. The system extracts a control command from this structured text. The system dynamically updates an access control list of a firewall. The system invalidates an authentication token of the corresponding account. By this processing, the system blocks a zero-day attack and an advanced targeted attack in real time. The system physically and logically contains expansion of damage. The system completely automates security operation work and eliminates human errors.

Furthermore, in the resource optimization unit, for example, when it is predicted that resources of a virtual server and a storage will be tight at a time when a business load increases, such as the end of a month or the end of a fiscal year, a past resource usage history, a business calendar, and event information are input into the generative AI, and future load fluctuation prediction and an optimal resource allocation plan are automatically generated. Specific examples of prompt sentences to be read by the generative AI include “Predict load fluctuation for the next one week based on a resource usage history and a business calendar for the past one month, and propose a plan for an increase or decrease in resources in natural language” and “Propose an automatic expansion procedure and a cost optimization measure when a storage capacity is tight”. The generative AI automatically generates a specific optimization proposal such as “Since it is predicted that CPU and memory usage rates of a virtual server group will exceed an average of 80 percent for three days at the end of the month, addition of two virtual servers and automatic expansion of a storage capacity are recommended. Since a usage rate decreases at night, reduction of resources is automatically executed”, for example, and presents it to the administrator terminal. Specifically, the resource optimization unit executes an autoregressive time-series prediction model. The resource optimization unit extracts a past resource usage rate as a continuous value vector. The resource optimization unit converts a business calendar and event information into a one-hot encoding vector. The resource optimization unit combines these vectors to construct an input tensor. The autoregressive time-series prediction model receives this input tensor. The autoregressive time-series prediction model calculates a predicted value of a resource usage rate over a plurality of future time steps. The autoregressive time-series prediction model generates a probabilistic output vector including a confidence interval of the predicted value. The resource optimization unit inputs this probabilistic output vector into a large language model. The large language model weighs prediction data against a cost constraint condition. The large language model outputs an allocation plan text including an optimal instance type of a virtual machine and a provisioning amount of a storage. The system parses this allocation plan text. The system transmits an API request for changing resource allocation to a hypervisor. By this processing, the system prevents performance degradation at a peak time. The system minimizes power consumption at an idle time. The system autonomously maintains an optimal balance between an infrastructure cost and service quality. The system realizes dynamic and predictive resource management that is impossible with static threshold-based control.

In this way, each unit cooperates to highly automate monitoring of the entire system, abnormality detection, failure cause estimation, security threat detection, attack route identification, resource optimization, cost reduction, business continuity securing, and the like utilizing the generative AI, and can dramatically improve safety, efficiency, and flexibility of the IT infrastructure while significantly reducing a burden on the administrator. Specifically, the system includes an orchestration layer that integrates functions of each unit. The orchestration layer executes a multi-agent reinforcement learning algorithm. The orchestration layer collects a state vector output from the system management unit or the security monitoring unit. The orchestration layer maps these state vectors to a global state space. The orchestration layer causes each agent to calculate an action value function. Each agent outputs an optimal action vector based on its own policy network. The orchestration layer arbitrates a conflict between action vectors of each agent. The orchestration layer synchronously updates a setting parameter of the entire system. The system applies this update result as an action to an environment. The system receives feedback from the environment as a reward signal. The system updates the policy network of each agent using this reward signal. By this processing, the system avoids falling into a local optimal solution. The system guarantees autonomous stable operation of the entire system. The system comprehensively and mathematically solves an operation issue of a complexly intertwined IT infrastructure. The system provides a computer system that achieves continuous self-evolution without human intervention.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically and in detail. The present invention targets various infrastructure devices in a data center, such as a server, a network device, a power supply facility, an air conditioning facility, a storage device, and a security facility, and is a system that centrally and automatically realizes real-time monitoring, abnormality detection, resource optimization, a preventive maintenance plan, failure response, energy management, security enhancement, and the like with generative AI at the core. Specifically, the system constructs a digital twin environment that imitates physical and logical states of the entire data center. The system continuously receives a multidimensional time-series tensor from a sensor group installed in each infrastructure device. The system integrates this multidimensional time-series tensor with coordinate data of a 3D space model. The system inputs the integrated data into a deep learning model. The deep learning model calculates a temperature distribution heat map and a power consumption prediction matrix in a space. The deep learning model outputs these prediction data in real time. The system dynamically adjusts an operating parameter of each facility based on this output data. The system transmits an instruction value of an optimal air volume and cooling water temperature to an air conditioning control unit. The system transmits a control signal for load balancing to a power supply facility. By this processing, the system dramatically improves power usage effectiveness of the data center. The system eliminates a local heat pool and extends a life of hardware. The system realizes a cyber-physical system in which a cyber space and a physical space are highly fused. The system breaks down conventional vertically-segmented facility management and provides an overall optimized autonomous operation infrastructure.

First, the server monitoring unit collects an operating status, a CPU usage rate, a memory usage rate, disk I/O, network traffic, temperature, humidity, power consumption, failure occurrence information, an event log, a system log, an application log, an access log, unauthorized intrusion detection information, and the like in real time from a physical server, a virtual server, a storage device, a network device, a power supply facility, an air conditioning facility, a security facility, and the like in a data center. For example, information is acquired by combining various means such as SNMP, Syslog, a REST API, agent software, a cloud monitoring service, and an IoT sensor. For example, when the CPU usage rate of a server A exceeds 90 percent, when the traffic of a network device B reaches 95 percent, when the I/O delay of a storage device C exceeds a threshold, when the temperature of an air conditioning facility D exceeds 30 degrees, when the power consumption of a power supply facility E exceeds 90 percent of a rating, or when an unauthorized intrusion detection system F detects an abnormality, a state change of any facility is immediately grasped. These data are analyzed by generative AI using advanced algorithms such as time-series analysis, abnormality detection, pattern recognition, clustering, and causal inference, and signs of complex abnormalities and failures are detected and diagnosed with high accuracy, such as, for example, “the high CPU load of the server A is estimated to be caused by resource contention due to a setting error of a backup job”, “the rapid increase in traffic of the network device B is a sign of a DDoS attack from the outside”, “the I/O delay of the storage device C is a sign of a disk failure”, “the temperature rise of the air conditioning facility D is caused by a decrease in cooling efficiency due to filter clogging”, “the rapid increase in power consumption of the power supply facility E is a peak load due to simultaneous startup of a server group”, and “the alert of the unauthorized intrusion detection system F is a suspicious access by an internal user”. When an abnormality or a high load is detected, the AI automatically generates an alert and immediately notifies an administrator terminal, a smartphone, a chat tool, an email, or the like by various means. Specifically, the server monitoring unit adopts a distributed processing architecture that links an edge computing node and a central AI cluster. The server monitoring unit concatenates metrics data collected from each device. The server monitoring unit generates, for example, a 1024-dimensional high-dimensional feature vector. The server monitoring unit inputs this high-dimensional feature vector to an autoencoder-based abnormality detection model. The abnormality detection model compresses the input vector into a low-dimensional latent space. The abnormality detection model reconstructs the original vector from the latent space. The abnormality detection model calculates a reconstruction error vector that is a difference between the input vector and the reconstructed vector. The server monitoring unit specifies a feature dimension having a high abnormality contribution degree from this reconstruction error vector. The server monitoring unit inputs this specified feature dimension and the original data to a causal inference network. The causal inference network generates a directed acyclic graph indicating a causal relationship between variables. The causal inference network specifies a node that is a root cause and outputs a probability score thereof. The server monitoring unit inputs this probability score and the graph structure to a large language model. The large language model outputs a diagnosis result as a natural language text. The system formats this text as an alert message. The system distributes the alert message to each notification channel via a message broker. By this processing, the system significantly reduces a communication band to a central server. The system detects an abnormality with a low delay in milliseconds. The system reliably captures a true threat or failure while minimizing false detection.

Next, the facility optimization unit inputs operation data, past history data, and external environment data (outside temperature, power rate, demand prediction, etc.) of a server group, a network device, an air conditioning facility, a power supply facility, a storage device, a security facility, and the like to generative AI, and automatically proposes and executes optimal resource allocation and an optimal operation mode. For example, when the CPU load of the server group is high, the AI proposes automatic distribution of workloads and expansion of virtual servers, and conversely, recommends automatic reduction of servers and transition to a power saving mode in a time zone with a low usage rate such as nighttime or a holiday. For example, when the temperature of the air conditioning facility is high, the AI proposes cooling enhancement and an operation mode change of the air conditioning equipment, and automatically generates an optimal cooling strategy according to changes in outside temperature and humidity. For example, when the power consumption of the power supply facility is soaring, the AI proposes transition of some servers to a power saving mode and peak cut operation, thereby realizing power cost reduction. For example, when the traffic of the network device is tight, the AI proposes optimization of a traffic route, QoS control, a scheduling change of a backup job, and the like. For example, when the capacity of the storage device is tight, the AI proposes automatic deletion of unnecessary data, storage expansion, data compression, automatic transition to cloud storage, and the like. These optimization proposals and automatic execution results are presented to the administrator terminal in an easy-to-understand manner, and the administrator can immediately perform approval, rejection, an additional instruction, and the like. Specifically, the facility optimization unit includes a control engine that executes a deep reinforcement learning algorithm. The facility optimization unit constructs a state vector representing a current environmental state. The state vector is, for example, a 256-dimensional numerical array including temperature, load, power price, and the like. The facility optimization unit inputs this state vector to a policy network. The policy network outputs a probability distribution of an operation for each facility. The facility optimization unit samples an optimal action vector from this probability distribution. The action vector includes a continuous value or a discrete value indicating a change amount of an air conditioning set temperature or a migration destination node of a workload. The facility optimization unit converts this action vector into a specific control command. The facility optimization unit transmits this control command to an actuator or a management API of each facility. The system observes a change in the environment after execution of the control. The system calculates a reward value based on a reduction amount of power consumption and an achievement degree of a service level agreement. The system updates a weight of the policy network using this reward value. By this processing, the system always maintains an optimal operation state with respect to a dynamically changing external environment. The system simultaneously maximizes energy efficiency and performance, which are in a complex trade-off relationship. The system solves a multivariable optimization problem that cannot be calculated by a human operator in real time.

Furthermore, the maintenance planning unit inputs an operating status, a history of occurrence of an abnormality, a resource usage tendency, failure sign data, facility life data, external maintenance information, and the like of each facility to generative AI, and realizes prioritization of preventive maintenance and inspection, automatic generation of a maintenance schedule, facility life prediction, notification to maintenance personnel, a parts replacement plan, automatic generation of a response procedure when a failure occurs, and the like. For example, a specific maintenance plan is automatically generated for each facility, such as “AI recommends preventive maintenance of server B” if the CPU or memory of a server B is in a high load state, “AI recommends inspection of air conditioning facility D” if the temperature of an air conditioning facility D is high, and “AI recommends inspection of power supply facility E” if the power consumption of a power supply facility E is high. For example, a detailed maintenance plan is automatically planned, such as “recommends disk replacement of storage device C” when the I/O delay of a storage device C tends to increase, “recommends firmware update of network device B” when traffic abnormalities of a network device B frequently occur, and “recommends sensor inspection of security facility F” when the alert frequency of a security facility F is increasing. The contents of the maintenance plan are automatically distributed to the administrator terminal and a terminal of maintenance personnel, thereby realizing efficiency of maintenance work and prevention of failures. Specifically, the maintenance planning unit executes a prediction engine combining a survival time analysis model and a recurrent neural network. The maintenance planning unit extracts an operating time and a past failure history of a facility as time-series sequence data. The maintenance planning unit inputs this time-series sequence data to the recurrent neural network. The recurrent neural network learns a temporal dependency and generates a hidden state vector. The maintenance planning unit inputs this hidden state vector to the survival time analysis model. The survival time analysis model calculates a hazard function of each facility. The survival time analysis model outputs a predicted value of a remaining useful life as a continuous value. The maintenance planning unit specifies a facility whose predicted value falls below a preset safety threshold. The maintenance planning unit inputs an identifier and prediction data of this specified facility to a large language model. The large language model outputs a maintenance plan text including a list of necessary replacement parts and a specific work procedure. The system converts this maintenance plan text into structured data. The system automatically registers a new work ticket in a maintenance management database. The system calls an API of a parts ordering system and automatically orders necessary parts. By this processing, the system reduces unplanned system downtime to the utmost limit. The system optimizes a parts inventory management cost. The system establishes standardized maintenance operation that does not depend on tacit knowledge of a skilled technician.

In addition, utilization of generative AI is the core of the present invention, and for example, for learning of an abnormality detection model, various data such as a past failure log, an operation history, security incident information, external threat intelligence, a business calendar, event information, facility configuration information, a user behavior history, and external environment data (weather, disaster information, social events, etc.) are used, and by continuously updating the model, it is possible to flexibly respond to environmental changes and new threats. For example, when an unknown attack method is discovered, it is also possible to automatically capture external threat intelligence information and strengthen the AI model. Furthermore, by utilizing a natural language generation function to automatically generate notifications and reports to an administrator, proposal contents, failure response procedures, background explanations of security incidents, basis explanations of resource optimization, simulation results of cost reduction effects, and the like in an easy-to-understand manner, even a person in charge without specialized knowledge can easily grasp a situation and make a decision. Specifically, the system executes an advanced data augmentation pipeline using a generative adversarial network. The system extracts log data and metrics data in a normal state as a multidimensional tensor. The system adds Gaussian noise to this multidimensional tensor. The system inputs a text token sequence extracted from external threat intelligence to a generator as a conditioning vector. The generator generates synthetic abnormality data imitating an unknown attack pattern or an extreme load state. The system inputs this synthetic abnormality data and actual observation data to a discriminator. The discriminator outputs a probability value for determining whether the input data is real or synthetic. The system adversarially trains the generator and the discriminator. The system updates a weight parameter so as to minimize a cross-entropy error. The system retrains a classifier using this trained model. The system deploys the retrained classifier to an inference environment. By this processing, the system fundamentally solves an imbalance problem of learning data. The system dramatically improves generalization performance against a zero-day attack or an unknown failure that has not been observed in the past. The system prevents obsolescence of the model and provides a self-evolving defense mechanism that always adapts to the latest threat environment.

For example, the server monitoring unit automatically diagnoses that “the memory usage rate of server G has rapidly increased in the past 24 hours and matches a past failure pattern, so a leak of process H is suspected”, the facility optimization unit automatically generates optimization proposals such as “proposes automatic stop at night because the usage rate of virtual server I is low”, “recommends filter cleaning because the cooling efficiency of air conditioning facility J is decreasing”, and “automatically executes peak cut operation because the power consumption of power supply facility K reaches a peak”, and the maintenance planning unit automatically plans a preventive maintenance plan for each facility, such as “recommends disk replacement due to an increase in I/O delay of storage device L”,

“recommends firmware update of network device M”, and “recommends sensor inspection of security facility N”. Specifically, the system includes a graph-based arbitration engine that integrally processes diagnosis results and proposal contents generated among a plurality of modules. The arbitration engine inputs text data output from each unit to a natural language processing model. The natural language processing model converts the text data into a high-dimensional embedding vector group. The arbitration engine constructs a directed acyclic graph having this embedding vector group as nodes. The arbitration engine calculates a dependency between nodes and a possibility of resource contention as an edge weight. The arbitration engine executes a topological sort on this directed acyclic graph. The arbitration engine determines an execution order of an action plan without contradiction as the entire system. The arbitration engine transmits a command queue to a task scheduler according to this execution order. The task scheduler sequentially executes each command. The system issues a restart command for the process H. The system calls a shutdown API of the virtual server I. The system transmits a peak cut signal to an inverter control unit of the power supply facility K. By this processing, the system safely arbitrates competing control commands issued by a plurality of autonomous modules. The system reliably performs complex automatic operation while maintaining consistency of the entire system. The system completely prevents an unexpected system crash during operation.

Furthermore, for example, when integrally managing a plurality of bases of a data center, facility data of each base is centrally collected via a cloud, and AI cross-sectionally analyzes an overall resource status and a failure occurrence tendency, thereby realizing resource accommodation between bases, minimization of a failure ripple risk, and overall optimization. For example, when a server group at a base A has a high load while there is a surplus resource at a base B, the AI proposes movement of a workload and automatic procurement of a cloud resource. For example, when an abnormality of an air conditioning facility occurs at a base C, the AI refers to cooling capacity and outside temperature data of another base, and automatically generates an optimal cooling strategy and a failure response procedure. For example, the AI analyzes power consumption data of all bases, and proposes peak cut, utilization of renewable energy, and power cost optimization. Specifically, the system executes model synchronization and knowledge sharing among a plurality of bases using a federated learning architecture. A local inference node arranged at each base performs learning of a local model using facility data of its own base. Each local inference node calculates a weight update vector obtained by learning. Each local inference node encrypts this weight update vector and transmits it to a central cloud integration server. The cloud integration server aggregates a plurality of received weight update vectors. The cloud integration server updates a weight parameter of a global model using a federated averaging algorithm. The cloud integration server redistributes the updated global model to each base. The system performs a resource optimization calculation between bases using this global model. The system inputs a state matrix indicating an overload state of the base A and a surplus state of the base B. The system outputs an optimal schedule vector of workload migration considering a network delay between bases. The system executes live migration of a virtual machine based on this schedule vector. By this processing, the system protects data privacy without transmitting raw data of each base to the outside. The system significantly saves a communication band between bases. The system constructs an AI model having advanced generalization performance integrating operation data of all bases.

Also, for example, to strengthen security of a data center, AI integrally analyzes an access log, a surveillance camera video, an entry/exit history, an authentication history, and external threat information, detects signs of internal fraud or an external attack at an early stage, and executes isolation of a corresponding user or terminal, an automatic change of an access authority, immediate notification to a related party, automatic generation of an incident report, and the like. For example, when there is an entry/exit through a route different from normal at night, the AI immediately issues a warning, automatically extracts and analyzes a surveillance camera video, and reports to an administrator. For example, when a DDoS attack from the outside is detected, the AI automatically executes a setting change of a network device and traffic blocking, and visualizes an attack route and an affected range. Specifically, the system executes an integrated security monitoring engine using a multimodal neural network. The monitoring engine converts an image frame acquired from a surveillance camera into a three-dimensional tensor. The monitoring engine converts an entry/exit log and an authentication history into a text embedding vector. The monitoring engine inputs the image tensor to a convolutional neural network and extracts an image feature vector. The monitoring engine inputs the text embedding vector to a transformer encoder and extracts a text feature vector. The monitoring engine calculates a cosine similarity score of these two feature vectors. The monitoring engine determines an abnormality when this similarity score falls below a threshold, that is, when there is a contradiction between the video and the log. The monitoring engine outputs bounding box coordinates of an image region where an abnormal behavior is detected. The system integrates this coordinate information and log data to generate an incident report. The system transmits an immediate lock command to an electronic lock in a corresponding area. The system executes an API call that invalidates a network access authority of a corresponding user. By this processing, the system realizes comprehensive defense eliminating a boundary between physical security and cyber security. The system reliably uncovers clever internal fraud that cannot be detected by a single data source. The system dramatically reduces a false alarm rate and prevents waste of security resources.

As described above, in the embodiment of the present invention, the server monitoring unit, the facility optimization unit, and the maintenance planning unit cooperate with generative AI as a core, and can comprehensively solve various and complex problems in data center operation, such as monitoring of the entire data center, abnormality detection, failure sign analysis, resource optimization, energy management, security enhancement, a preventive maintenance plan, failure response automation, cost reduction, business continuity improvement, automatic inheritance of operation know-how, and flexible response to external environmental changes. Specifically, the system executes an automatic update mechanism of an AI model through a continuous integration and continuous deployment pipeline. The system continuously measures a difference between an inference result during operation and an actual system state. The system quantifies this difference as an error vector. The system fires a trigger signal for retraining when a moving average of this error vector exceeds an allowable threshold. The system starts learning of a new model in the background using the latest collected data. The system assigns a version tag to the new model whose learning has been completed. The system connects the new model in parallel to a data stream of a production environment using a shadow deployment method. The system compares and evaluates inference accuracy of the new and old models in real time. The system switches traffic routing to the new model when determining that performance improvement of the new model is statistically significant. By this processing, the system completely eliminates manual model update work by a human engineer. The system continues to autonomously adapt to changes in an operation environment of a data center. The system dramatically reduces a long-term operation cost. The system always maintains an inference engine with the highest performance and guarantees self-evolution of the system.

### System Configuration

The system according to the present embodiment includes a server monitoring unit, a facility optimization unit, a maintenance planning unit, a data collection unit, an AI learning/inference unit, a user interface unit, and a notification/report generation unit. The server monitoring unit collects an operating status, a CPU usage rate, a memory usage rate, disk I/O, network traffic, temperature, humidity, power consumption, failure occurrence information, an event log, a system log, an application log, an access log, unauthorized intrusion detection information, and the like in real time from various infrastructure devices such as a physical server, a virtual server, a storage device, a network device, a power supply facility, an air conditioning facility, and a security facility in a data center. For example, information is acquired by combining a plurality of means such as SNMP, Syslog, a REST API, agent software, a cloud monitoring service, and an IoT sensor, and when the CPU usage rate of a server A exceeds 90 percent, when the traffic of a network device B reaches 95 percent, when the I/O delay of a storage device C exceeds a threshold, when the temperature of an air conditioning facility D exceeds 30 degrees, when the power consumption of a power supply facility E exceeds 90 percent of a rating, or when an unauthorized intrusion detection system F detects an abnormality, a state change of any facility is immediately grasped. The server monitoring unit also performs preprocessing, normalization, correction of an abnormal value, shaping of time-series data, and the like for inputting these data to generative AI, generates prompt sentences such as, for example, “analyze time-series data of CPU, memory, and disk usage rates of a server group, and explain an abnormal tendency and a sign of a failure in natural language”, “extract a pattern different from normal from a traffic log of a network device, and estimate a cause”, and “the CPU usage rate of a virtual server has exceeded 90 percent since 13:00 today. collate with a past failure pattern, and output a cause and a recommended countermeasure”, and instructs the AI to perform analysis. Specifically, the data collection unit and the server monitoring unit execute a stream processing engine using a distributed message queue. The data collection unit asynchronously receives raw metrics data reaching millions of cases per second. The data collection unit divides this raw data for each time window. The data collection unit aggregates data in each time window and generates a feature tensor. The server monitoring unit applies Z-score normalization to this feature tensor. The server monitoring unit complements a missing value with a linear interpolation algorithm. The server monitoring unit inputs clean tensor data for which preprocessing has been completed to a transformer-based abnormality detection model. The abnormality detection model calculates a correlation between respective metrics using a multi-head attention mechanism. The abnormality detection model outputs an array of abnormality scores. The server monitoring unit extracts a data point whose abnormality score exceeds a threshold. The server monitoring unit inserts this extracted data point into a natural language prompt template. The server monitoring unit transmits this prompt to an API endpoint of a large language model. By this processing, the system establishes a high-throughput and low-delay data processing pipeline. The system prevents processing delay and data loss even for a sudden traffic spike. The system completely ensures scalability in a large-scale data center.

The facility optimization unit inputs operation data and past history data of a server group, network devices, air conditioning facilities, power supply facilities, storage devices, security facilities, and the like, and external environment data (outside air temperature, power rates, demand prediction, and the like) into generative AI, and automatically proposes and executes optimal resource allocation and an operation mode. For example, when a CPU load of the server group is high, the AI proposes automatic distribution of workloads and expansion of virtual servers, and conversely, in a time zone with a low usage rate such as nighttime or a holiday, recommends automatic reduction of servers and transition to a power saving mode. When a temperature of the air conditioning facilities is high, the AI proposes cooling enhancement and an operation mode change of air conditioning equipment, and automatically generates an optimal cooling strategy according to changes in outside air temperature and humidity. When power consumption of the power supply facilities is soaring, the AI proposes transition of some servers to the power saving mode and peak cut operation, and realizes power cost reduction. When traffic of the network devices is tight, the AI proposes optimization of a traffic route, QoS control, a scheduling change of a backup job, and the like. When a capacity of the storage devices is tight, the AI proposes automatic deletion of unnecessary data, storage expansion, data compression, automatic transition to cloud storage, and the like. The facility optimization unit generates prompt sentences such as, for example, “Predict load fluctuation for the next week based on a resource usage history for the past month and a business calendar, and propose a plan for an increase or decrease in resources in natural language,” “Propose a cooling efficiency improvement measure based on temperature transition of air conditioning facilities and outside air temperature data,” “Propose a future peak time countermeasure from a fluctuation pattern of network traffic for the past week,” and “Predict a next inspection time based on a usage rate and a failure history of power supply facilities,” and gives an optimization instruction to the AI. Specifically, the facility optimization unit executes a hybrid engine integrating a mathematical optimization solver for solving a constrained nonlinear optimization problem and a neural network. The facility optimization unit formulates a power consumption model of each facility. The facility optimization unit defines a performance requirement based on a service level agreement as a constraint matrix. The facility optimization unit inputs the constraint matrix and a current environment state vector into the neural network. The neural network outputs an initial solution vector for minimizing a total operation cost which is an objective function. The facility optimization unit sets the initial solution vector as an initial value of the mathematical optimization solver. The mathematical optimization solver searches for a strict optimal solution vector using a gradient descent method. The optimal solution vector is a set of specific setting values of each facility. The facility optimization unit inputs the optimal solution vector into a large language model. The large language model generates a proposal text in natural language describing a reason for a setting change and an expected effect. The system presents the proposal text to an administrator and simultaneously executes an API call for a batch setting change based on a setting value vector. By this processing, the system derives an optimal solution under complex constraint conditions at high speed and accurately. The system completely prevents a system failure due to an operation error. The system makes a judgment basis of the AI, which tends to be a black box, transparent, and acquires trust of the administrator.

The maintenance planning unit inputs an operating status, a history of occurrence of an abnormality, a resource usage tendency, failure sign data, facility life data, external maintenance information, and the like of each facility into generative AI, and realizes prioritization of preventive maintenance and inspection, automatic generation of a maintenance schedule, facility life prediction, notification to maintenance personnel, a parts replacement plan, automatic generation of a response procedure when a failure occurs, and the like. For example, if a CPU and a memory of a server B are in a high load state, “AI recommends preventive maintenance of server B” is set, if a temperature of air conditioning facilities D is high, “AI recommends inspection of air conditioning facilities D” is set, and if power consumption of power supply facilities E is high, “AI recommends inspection of power supply facilities E” is set, and a specific maintenance plan is automatically generated for each facility. When an I/O delay of a storage device C is on an increasing trend, “recommends disk replacement of storage device C” is set, when a traffic abnormality of a network device B frequently occurs, “recommends firmware update of network device B” is set, and when an alert frequency of security facilities F is increasing, “recommends sensor inspection of security facilities F” is set, and a detailed maintenance plan is automatically drafted. The maintenance planning unit generates prompt sentences such as, for example, “Analyze a failure occurrence history and a resource usage tendency of a server group, and output a priority of next preventive maintenance in natural language,” “Propose an optimal inspection time based on a temperature abnormality and a filter cleaning history of air conditioning facilities,” “Analyze an I/O delay increase and disk life data of a storage device, and output a recommended replacement time,” and “Automatically generate a maintenance plan based on a traffic abnormality and a firmware update history of a network device,” and gives a maintenance plan instruction to the AI. Specifically, the maintenance planning unit executes a dynamic maintenance manual generation engine using a natural language processing model. The maintenance planning unit vectorizes a model number and a predicted failure mode of a target facility. The maintenance planning unit converts a past response history text into an embedding vector. The maintenance planning unit combines these vectors to generate a context vector. The maintenance planning unit inputs the context vector into a transformer-based text generation model. The text generation model outputs a token sequence indicating a step-by-step specific work procedure. The maintenance planning unit analyzes the token sequence and generates structured procedure manual data including necessary tools and safety confirmation items. The system streams and distributes the procedure manual data to a wearable device worn by maintenance personnel at a site. The system tracks work progress of the maintenance personnel in real time through voice recognition and image recognition. The system immediately issues a warning when detecting a work delay or a procedure error. By this processing, the system equalizes and standardizes quality of maintenance work. The system significantly shortens a work time. The system provides an environment in which even an inexperienced worker can complete a maintenance task with accuracy equivalent to that of an expert.

The data collection unit collects necessary data in real time or periodically from various information processing apparatuses, network devices, cloud services, business applications, external databases, threat intelligence services, and the like, performs data preprocessing, normalization, missing value complementation, abnormal value detection, format conversion, time-series shaping, metadata addition, and the like, and provides the data to an AI learning/inference unit and each unit. For example, it supports various data sources such as reception of an SNMP trap and a Syslog message, acquisition of cloud resource information by an API, collection of terminal information by agent software, automatic acquisition of external threat intelligence, and import of a business calendar and event information. Specifically, the data collection unit executes a feature engineering pipeline using an automated machine learning framework. The data collection unit expands raw multidimensional data arrays collected from various sources on a memory. The data collection unit applies statistical filtering to the data arrays and removes outliers. The data collection unit applies a complementation algorithm based on a K-nearest neighbor method to missing values. The data collection unit converts categorical data into a one-hot vector. The data collection unit normalizes continuous value data by min-max scaling. The data collection unit generates clean tensor data through these processes. The data collection unit inputs the tensor data into a feature selection algorithm. The feature selection algorithm calculates variable importance of a random forest. The feature selection algorithm deletes a redundant dimension that does not contribute to inference and performs dimensionality reduction. The data collection unit outputs an optimized feature tensor to a shared memory area. The system transfers data to the AI learning/inference unit at high speed via the shared memory area. By this processing, the system maximizes inference accuracy of a subsequent AI model. The system suppresses consumption of unnecessary computational resources and improves processing efficiency. The system completely automates manual data preprocessing work by a data scientist.

The AI learning/inference unit performs learning and inference of an abnormality detection model, a threat detection model, a resource optimization model, a natural language generation model, and the like using various data provided from the data collection unit. For example, the model is continuously updated using a past failure log, an operation history, security incident information, external threat intelligence, a business calendar, event information, facility configuration information, a user behavior history, external environment data, and the like, and flexibly responds to an environmental change and a new threat. The AI learning/inference unit receives a prompt sentence from each unit, executes analysis, inference, and natural language generation, and returns a result to each unit. Specifically, the AI learning/inference unit controls a parallel computing cluster using a plurality of image processing semiconductors. The AI learning/inference unit divides a large-scale learning data set into mini-batch tensors. The AI learning/inference unit distributes the mini-batch tensors to each computing node using a data parallelization algorithm. Each computing node executes calculation of a forward pass and a backward pass using the allocated data. Each computing node calculates a gradient vector of a weight parameter with respect to a loss function. The AI learning/inference unit synchronizes the gradient vector among all nodes using a ring all-reduce algorithm. The AI learning/inference unit calculates an average value of the synchronized gradients. The AI learning/inference unit drives an optimizer using the average gradient and updates a global weight parameter. The AI learning/inference unit processes an inference request using the updated model. The AI learning/inference unit tokenizes the input prompt sentence and inputs it into the model. The AI learning/inference unit decodes an optimal text sequence from an output probability distribution. By this processing, the system significantly shortens a learning time of a huge neural network on a scale of billions of parameters. The system guarantees a response speed in milliseconds to a real-time inference request. The system realizes complete intelligentization of infrastructure management by making full use of advanced computing capability.

The user interface unit operates on an administrator terminal, and receives and displays, in real time, an alert, a threat detection result, a resource optimization proposal, an execution history, a failure response history, a security incident report, a resource usage prediction, a cost analysis report, a system configuration diagram, a dependency map, a failure ripple simulation result, and the like generated on a server side. An operating status of the entire system is graphically displayed on a dashboard screen, and when an alert occurs, it is immediately transmitted to an administrator by various methods such as a pop-up notification, an email notification, a chat notification, and a push notification to a smartphone. The administrator can perform, from the terminal to the server, approval/rejection of an optimization proposal, an additional response instruction, a request for a detailed report, prioritization of a failure response, escalation of a security incident, manual adjustment of resource allocation, a relearning instruction of an AI model, a cooperation setting with an external system, and the like. Specifically, the user interface unit is expanded on a memory of the administrator terminal including a graphical processing unit. The user interface unit receives a serialized JSON format data stream transmitted from the server side. The data stream includes a floating-point score indicating importance of an alert, a probability distribution vector of threat detection, and multidimensional tensor data for resource optimization. The user interface unit decodes the received data stream. The user interface unit converts the decoded data into a two-dimensional pixel array. The user interface unit outputs the pixel array to a display device. The user interface unit captures an input operation from the administrator. The input operation is acquired as coordinate data of a mouse click or keystroke data of a keyboard. The user interface unit converts the input operation data into a specific command vector. The user interface unit transmits the command vector to the server via a secure communication protocol. The server receives the command vector. The server dynamically updates a hyperparameter of a large language model based on the command vector. The large language model includes a self-attention mechanism based on a transformer architecture. By this update processing, the system improves inference accuracy of the AI model. This configuration is not limited to mere display of information, but forms a feedback loop between the administrator and the AI model. The feedback loop optimizes a relearning process of the model. By this optimization, the system exerts a technical effect of improving a convergence speed of inference while reducing consumption of computational resources. The technical effect is brought about by dynamic control of a gradient descent method in a high-dimensional vector space, which cannot be realized by human mental activity. The system applies the user interface unit to a specific use case of an integrated monitoring console of a large-scale data center. By this application, the system minimizes a delay in incident response.

The notification and report generation unit automatically generates, in natural language, an alert notification for an administrator, a detailed report, an incident background explanation, a basis explanation of resource optimization, a simulation result of a cost reduction effect, a failure response procedure, a background explanation of a security incident, a dependency map, a failure ripple simulation result, and the like based on an output result of the AI learning/inference unit, and presents them to the administrator through the user interface unit. For example, it automatically generates a specific and easy-to-understand explanation such as “A memory usage rate of a server C has rapidly increased in the past 24 hours, and a leak of a process D is suspected,” “A port scan to a network device E was detected, and communication from a corresponding IP address was blocked,” “Since a usage rate of a virtual server F is low, automatic suspension at night is proposed,” and “Since a cost of a cloud service G is soaring, workload transition to on-premises H is proposed.” Specifically, the notification and report generation unit acquires a high-dimensional hidden state vector output from the AI learning/inference unit. The hidden state vector is configured as an array of 512-dimensional floating-point numbers. The notification and report generation unit inputs the hidden state vector into a natural language generation model. The natural language generation model is a pre-trained transformer network having billions of parameters. The natural language generation model processes the input hidden state vector by a decoder network. The decoder network outputs a probability distribution in a vocabulary space of words. The notification and report generation unit applies a beam search algorithm to the probability distribution. The beam search algorithm autoregressively generates a word sequence with the highest probability. By this generation processing, the notification and report generation unit converts machine-readable log data into natural language text understandable by a human. The notification and report generation unit maps the generated text to a structured report format. The report format is encoded as binary data in an HTML or PDF format. The notification and report generation unit transmits the binary data to the administrator terminal. In this processing, the natural language generation model is fine-tuned using a large-scale corpus including a past incident response history. The fine-tuning includes a process of updating a weight parameter so as to minimize a cross-entropy error function. With this configuration, the system realizes dynamic report generation depending on a context, rather than a mere combination of fixed phrases. The dynamic generation exerts a technical effect of reducing a cognitive load on the administrator and improving a decision-making speed of a failure response. The technical effect is realized by a nonlinear conversion mechanism that maps a complex system state to a low-dimensional natural language space. The system applies the notification and report generation unit to a specific use case of an automatic operation service of cloud infrastructure. By this application, the system significantly reduces an operation cost.

Specific examples of prompt sentences to be read by generative AI necessary for implementing the present invention include “Analyze time-series data of CPU, memory, and disk usage rates of a server group, and explain an abnormal tendency and a sign of a failure in natural language,” “Analyze an access log and an authentication history from 0:00 today to the present, extract an access pattern different from normal and suspicious behavior, and evaluate a threat level,” “Predict load fluctuation for the next week based on a resource usage history for the past month and a business calendar, and propose a plan for an increase or decrease in resources in natural language,” “Collate a latest ransomware attack method with a communication log of this system, and report presence or absence of a similar pattern,” “A CPU usage rate of a virtual server has exceeded 90 percent since 13:00 today. Collate with a past failure pattern, and output a cause and a recommended countermeasure,” and “Continuous authentication failures from 2:00 midnight by a user B are recorded 100 times or more. Evaluate a possibility of a brute force attack, and output a recommended countermeasure.” Specifically, the system inputs these prompt sentences into the generative AI not as a mere character string but as a sequence of tokenized integer IDs. The system tokenizes the prompt sentences using a byte pair encoding algorithm. The system converts each token ID into a multidimensional word embedding vector. The system adds a positional encoding vector to the word embedding vector. By this addition processing, the system retains order information of an input sequence. The system combines time-series metrics data of a target system as a numerical tensor together with the prompt sentence. For example, the system includes a CPU usage rate for the past 24 hours in the input as a one-dimensional tensor consisting of 1440 floating-point numbers. The generative AI inputs the combined input tensor into a self-attention mechanism. The self-attention mechanism executes a matrix product operation using a query matrix, a key matrix, and a value matrix. By this operation, the generative AI extracts a long-range dependency relationship in the input data. The generative AI generates, as an output, a probability distribution of text tokens indicating a recommended countermeasure. The system samples a token sequence with the highest likelihood from the probability distribution. The system decodes the sampled token sequence and generates an executable script or a setting change command. The system automatically issues the command to a target server or network device. With this configuration, the system realizes seamless conversion from an instruction in natural language to a specific system control command. This conversion processing enables fully automated closed-loop control excluding human intervention. The closed-loop control exerts a technical effect of shortening a failure recovery time to milliseconds. The technical effect is brought about by a mechanism that directly connects inference capability of a large language model to physical hardware control. The system applies the prompt processing mechanism to a specific use case of dynamic access control of a zero trust network.

As described above, the system according to the present embodiment has a configuration in which each unit cooperates to collect, analyze, optimize, and notify various information, and comprehensively realizes unified and advanced automatic operation of the entire data center, security enhancement, resource optimization, cost reduction, business continuity improvement, failure response speeding up, human risk reduction, automatic inheritance of operation know-how, flexible response to external environment changes, and the like with generative AI at the core. Specifically, the system adopts an architecture that couples a plurality of independent processing modules via a high-speed internal bus and a shared memory space. The system exchanges data between the modules using an asynchronous message passing interface. The system includes a dedicated tensor processing unit cluster for hosting the generative AI. The tensor processing unit cluster drives thousands of computing cores in parallel. The system stores a huge amount of collected telemetry data in a distributed file system. The system inputs the telemetry data into a real-time stream processing engine. The stream processing engine divides the data into chunks for each certain time using a sliding window algorithm. The system sequentially supplies the chunked data to an inference pipeline of the generative AI. The generative AI executes a forward propagation operation on the input data and extracts a latent representation vector of a system state. The system inputs the latent representation vector into a clustering algorithm and classifies a current system state into any of a plurality of known operation modes. The system autonomously changes a dynamic allocation policy of resources based on a classification result. With this configuration, the system optimizes an operation state of the entire data center from a macro perspective. This optimization processing realizes total optimization exceeding a sum of optimization of individual devices. The total optimization exerts a technical effect of dramatically reducing total power consumption of the data center and extending a mean time between failures of hardware. The technical effect is achieved by a complex mechanism of pattern recognition in a high-dimensional data space by generative AI and search for an optimal policy by a reinforcement learning agent. The system applies the integrated architecture to a specific use case of integrated management of global cloud infrastructure spanning multiple regions. By this application, the system maximizes usage efficiency of geographically distributed resources.

### Implementation Steps

### Step 1: Data Collection and Preprocessing

In this step, a wide variety of data such as a CPU usage rate, a memory usage rate, disk I/O, network traffic, temperature, humidity, power consumption, failure occurrence information, an event log, a system log, an application log, an access log, and unauthorized intrusion detection information are collected in real time or periodically from all facilities in a data center, such as a physical server, a virtual server, a storage device, a network device, power supply facilities, air conditioning facilities, and security facilities, data is acquired utilizing SNMP, Syslog, a REST API, agent software, a cloud monitoring service, an IoT sensor, and the like, preprocessing such as missing value complementation, abnormal value detection, normalization, format conversion, time-series shaping, and metadata addition is performed, and the data is provided to an AI learning/inference unit and each unit. Specifically, the data collection unit periodically receives metrics data together with a heartbeat signal from an agent program arranged in each facility. The data collection unit temporarily stores the received data in a ring buffer of an in-memory database. The data collection unit reads the data from the ring buffer and inputs the data into a preprocessing pipeline. The preprocessing pipeline first executes a missing value complementation module. The missing value complementation module statistically estimates and interpolates a missing data point using a Kalman filter or an autoregressive moving average model. The preprocessing pipeline next executes an abnormal value detection module. The abnormal value detection module identifies a statistical outlier using an isolation forest algorithm and removes it as noise. The preprocessing pipeline subsequently executes a normalization module. The normalization module standardizes a value of each metric to have zero mean and unit variance. This standardization processing is indispensable for enabling sensor data having different scales to be processed by the same neural network. The preprocessing pipeline finally executes a time-series shaping module. The time-series shaping module converts continuous data points into a three-dimensional tensor having a fixed-length time step. The three-dimensional tensor has three axes of a batch size, the number of time steps, and a feature dimension. The data collection unit transfers the three-dimensional tensor to an input interface of the AI learning/inference unit. With this configuration, the system converts noisy raw sensor data into a high-quality feature representation processable by a machine learning model. This conversion processing exerts a technical effect of dramatically improving inference accuracy of a subsequent AI model and reducing a false positive rate. The technical effect is realized by a mathematical conversion mechanism that filters a noise component while retaining a topological structure of a data space. The system applies the preprocessing method to a specific use case of real-time abnormality detection in an edge computing environment.

Step 2: System state monitoring and abnormality detection (utilization of generative AI) In this step, the server monitoring unit inputs preprocessed data to the generative AI, and causes the generative AI to analyze the operating status and load status of the entire system, and failure signs. Specific examples of prompt sentences to be read by the generative AI include “Analyze time-series data of CPU, memory, and disk usage rates of a server group, and explain an abnormal tendency and a failure sign in natural language”, “Extract a pattern different from a normal time from a traffic log of a network device, and estimate a cause”, and “The CPU usage rate of a virtual server has exceeded 90 percent since 13:00 today. Collate with past failure patterns, and output a cause and a recommended countermeasure”. Based on these prompts, the AI performs detection of an abnormal pattern, estimation of a failure cause, and automatic generation of a recommended countermeasure. Specifically, the server monitoring unit inputs the preprocessed three-dimensional tensor data to an encoder network of the generative AI. The encoder network is composed of a plurality of convolutional layers and long short-term memory layers. The encoder network extracts temporal and spatial features from the time-series data, and generates a fixed-length context vector. The server monitoring unit combines the context vector and an embedding vector obtained by tokenizing the prompt sentence. The server monitoring unit inputs the combined vector to a decoder network of the generative AI. The decoder network employs a transformer architecture. The decoder network autoregressively generates a text token indicating a diagnosis result of the system state based on the input vector. The generative AI generates, as an output, a continuous value score from 0 to 1 indicating an occurrence probability of an abnormality, a categorical label indicating a root cause of the abnormality, and a natural language text indicating a recommended response procedure. For example, the generative AI detects a periodic spike pattern from the input tensor of the CPU usage rate, and outputs a root cause label of “resource depletion due to conflict of backup processes”. The server monitoring unit triggers an automatic repair module when the continuous value score exceeds a preset threshold value. The automatic repair module analyzes the generated recommended response procedure, and issues a system call to lower a priority of a corresponding process. With this configuration, the system dynamically identifies a complex abnormal pattern that cannot be detected by conventional static threshold-based monitoring. This dynamic identification exerts a technical effect of preventing system downtime and improving availability. This technical effect is brought about by a nonlinear feature extraction mechanism of high-dimensional time-series data by a deep learning model. The system applies the abnormality detection mechanism to a specific use case of monitoring a mission-critical transaction system of a financial institution.

Step 3: Facility optimization and operation proposal (utilization of generative AI) In this step, the facility optimization unit inputs a resource usage status, a business calendar, event information, an outside air temperature, an electricity rate, a demand prediction, an external system cooperation status, and the like to the generative AI, and automatically generates optimal resource allocation and an operation proposal. Specific examples of prompt sentences to be read by the generative AI include “Predict a load fluctuation for the next one week based on a resource usage history for the past one month and a business calendar, and propose a plan for an increase or decrease in resources in natural language”, “Propose a cooling efficiency improvement measure based on a temperature transition of an air conditioning facility and outside air temperature data”, “Propose a future peak time countermeasure from a fluctuation pattern of network traffic for the past one week”, and “Predict a next inspection time based on a usage rate and a failure history of a power supply facility”. Based on these prompts, the AI automatically generates a dynamic scaling plan, a resource reduction plan, air conditioning operation optimization, a power cost reduction measure, network route optimization, a storage expansion plan, and the like. Specifically, the facility optimization unit integrates time-series data of the resource usage status, an event flag of the business calendar, and numerical data of the outside air temperature to construct a multivariate time-series tensor. The facility optimization unit inputs the multivariate time-series tensor to a prediction model of the generative AI. The prediction model has a hybrid architecture combining a graph neural network and a self-attention mechanism. The prediction model expresses physical and logical dependencies between facilities as an adjacency matrix, and executes a graph convolution operation. The prediction model predicts a resource demand of each facility at a plurality of future time steps, and outputs a tensor of predicted values. The facility optimization unit inputs the tensor of predicted values as an environmental state of a reinforcement learning agent. The reinforcement learning agent is trained using a policy gradient method based on a Markov decision process. The reinforcement learning agent outputs an optimal action vector so as to maximize a reward function aimed at minimizing power consumption and maximizing system performance. The action vector includes an ID of a migration destination node of each virtual machine, an increase/decrease value of a set temperature of the air conditioning facility, and a bandwidth limit value of a network switch. The facility optimization unit converts the action vector into a specific control command, and applies the control command to each facility via an orchestration engine. With this configuration, the system realizes data-driven facility control that does not depend on human rules of thumb. This data-driven control exerts a technical effect of optimizing energy efficiency of the entire data center and reducing operation costs. This technical effect is achieved by a mechanism of modeling spatial dependencies by the graph neural network and optimizing long-term rewards by reinforcement learning. The system applies the optimization mechanism to a specific use case of operating a green data center linked with a district heating and cooling system in a smart city.

Step 4: Maintenance plan and preventive maintenance (utilization of generative AI) In this step, the maintenance planning unit inputs an operating status, a history of occurrence of an abnormality, a resource usage tendency, failure sign data, facility life data, external maintenance information, and the like of each facility to the generative AI, and realizes prioritization of preventive maintenance and inspection, automatic generation of a maintenance schedule, facility life prediction, notification to maintenance personnel, a parts replacement plan, automatic generation of a response procedure when a failure occurs, and the like. Specific examples of prompt sentences to be read by the generative AI include “Analyze a failure occurrence history and a resource usage tendency of a server group, and output a priority of next preventive maintenance in natural language”, “Propose an optimal inspection time based on a temperature abnormality and a filter cleaning history of an air conditioning facility”, “Analyze an increase in I/O delay and disk life data of a storage device, and output a recommended replacement time”, and “Automatically generate a maintenance plan based on a traffic abnormality and a firmware update history of a network device”. Based on these prompts, the AI automatically generates a preventive maintenance plan, an inspection schedule, a parts replacement time, a failure response procedure, and the like for each facility. Specifically, the maintenance planning unit constructs a multidimensional feature vector including an operating time, a temperature cycle, vibration data, and a past failure history of each facility. The maintenance planning unit inputs the feature vector to a survival time analysis model of the generative AI. The survival time analysis model is a parametric deep learning network assuming a Weibull distribution. The survival time analysis model predicts a remaining useful life of each facility based on the input feature vector. The survival time analysis model generates, as an output, curve data of a hazard function indicating a probability that each facility will fail within a specific period. The maintenance planning unit analyzes the curve data of the hazard function, and specifies a date and time when the failure probability exceeds an allowable threshold value. The maintenance planning unit inputs the specified date and time, and data of a shift schedule of maintenance personnel and an inventory status of replacement parts as constraint conditions to a mixed integer linear programming solver. The solver calculates an optimal maintenance schedule that avoids system downtime while minimizing the total cost of maintenance work. The maintenance planning unit inputs the calculated schedule to a language model of the generative AI, and causes the language model to generate a specific work instruction for the maintenance personnel in natural language. The work instruction includes a part number to be replaced, necessary tools, and safety precautions. The maintenance planning unit automatically transmits the work instruction to a mobile terminal of the maintenance personnel. With this configuration, the system realizes a paradigm shift from reactive maintenance to predictive preventive maintenance. This predictive maintenance exerts a technical effect of preventing a sudden system stop and optimizing an inventory management cost of parts. This technical effect is brought about by an integrated mechanism of highly accurate life prediction by deep learning and scheduling by a mathematical optimization algorithm. The system applies the preventive maintenance mechanism to a specific use case of fleet management of an industrial robot group in a large-scale manufacturing industry.

Step 5: Notification/report generation and administrator interface cooperation In this step, based on an output result of an AI learning/inference unit, a notification/report generation unit automatically generates an alert notification for an administrator, a detailed report, an explanation of an incident background, an explanation of a basis for resource optimization, a simulation result of a cost reduction effect, a failure response procedure, an explanation of a background of a security incident, a dependency map, a failure ripple simulation result, and the like in natural language, and presents them to an administrator terminal in real time through a user interface unit. The administrator can perform approval/rejection of an optimization proposal, an additional response instruction, a request for a detailed report, prioritization of a failure response, escalation of a security incident, manual adjustment of resource allocation, a retraining instruction for an AI model, a cooperation setting with an external system, and the like from the terminal, enabling bidirectional interaction. Specifically, the notification/report generation unit acquires a probability tensor of abnormality detection and an optimization action vector output from the AI learning/inference unit. The notification/report generation unit inputs these numerical data to a hybrid pipeline of a template-based rule engine and a large language model. The hybrid pipeline evaluates the importance of the numerical data, and immediately generates a short alert text when the urgency is high. The hybrid pipeline generates a long report including a detailed context when the urgency is low. The notification/report generation unit transmits data points for drawing a time-series graph indicating a transition of a system state to the user interface unit together with the generated text data. The user interface unit is implemented as a single-page application operating on a web browser. The user interface unit renders a dynamic graph on a canvas element using the received data points. When the administrator clicks a specific data point on the graph, the user interface unit transmits an API call requesting system snapshot data at that time to the server. The server acquires the requested snapshot data, inputs the snapshot data to the generative AI, and causes the generative AI to execute a detailed cause analysis. The server returns an analysis result to the user interface unit. The user interface unit packages an approval command or a parameter adjustment command input by the administrator as a JSON payload, and transmits the JSON payload to the server. The server analyzes the payload, and issues a control command to a target facility. With this configuration, the system constructs a human-in-the-loop system that seamlessly integrates autonomous inference of AI and professional judgment of a human. This integration exerts a technical effect of preventing black-boxing of full automation and ensuring transparency and controllability of the system. This technical effect is realized by a real-time state synchronization mechanism using an asynchronous communication protocol. The system applies the interface cooperation mechanism to a specific use case of a security operation center of critical infrastructure.

### Specific Use Case

For example, assume a large-scale infrastructure environment in which a plurality of physical servers and virtual servers coexist in a data center, and network devices, storage devices, power supply facilities, air conditioning facilities, security facilities, and the like are operating. In this environment, the server monitoring unit collects a CPU usage rate, a memory usage rate, disk I/O, network traffic, temperature, failure occurrence information, an event log, a system log, an application log, and the like of each server in real time, and gives a prompt such as “Analyze time-series data of CPU, memory, and disk usage rates of a server group, and explain an abnormal tendency and a failure sign in natural language” to the generative AI, whereby the AI can automatically generate a diagnosis such as “The CPU usage rate of server A has exceeded an average of 90 percent in the past 24 hours, and it is estimated that the cause is resource conflict due to a setting mistake of a backup job”. Specifically, the server monitoring unit acquires hardware-level sensor data from a baseboard management controller of each physical server via an IPMI protocol. The server monitoring unit acquires data of resource allocation and consumption status of each virtual machine via an API of a hypervisor. The server monitoring unit normalizes these heterogeneous data into a common data schema, and constructs a multidimensional time-series tensor with synchronized timestamps. The multidimensional time-series tensor is expressed as a huge matrix including, for example, 1000 servers×50 types of features×data points with a 1- minute granularity for the past 24 hours. The server monitoring unit inputs the multidimensional time-series tensor to a transformer encoder of the generative AI. The transformer encoder calculates a hidden correlation between a CPU spike of a specific server and a disk I/O delay of another server using a self-attention mechanism. The generative AI analyzes a weight matrix of the correlation, and specifies that a root cause of an abnormality is lock conflict due to simultaneous access to a network shared storage. The generative AI outputs the specified cause as a natural language diagnosis report. The diagnosis report includes a specific process ID that caused the abnormality, a list of affected virtual machines, and a recommended limit value of a storage I/O band. The server monitoring unit push-notifies the diagnosis report to a dashboard of an administrator. With this configuration, the system early detects a complex chain of failures spanning the entire system, which cannot be found by threshold monitoring of a single metric. This early detection exerts a technical effect of preventing development into a large-scale failure and guaranteeing compliance with a service level agreement. This technical effect is brought about by modeling of a global context by a transformer architecture and a cross-modal feature extraction mechanism of heterogeneous data. The system applies the diagnosis mechanism to a specific use case of monitoring a multi-tenant environment of a public cloud provider.

Further, the facility optimization unit gives a prompt such as “Predict a load fluctuation for the next one week based on a resource usage history for the past one month and a business calendar, and propose a plan for an increase or decrease in resources in natural language” to the generative AI, and the AI automatically generates an optimization proposal such as “Since it is predicted that the CPU and memory usage rates of the virtual server group will exceed an average of 80 percent for three days at the end of the month, addition of two virtual servers and automatic expansion of a storage capacity are recommended. Since the usage rate decreases at night, reduction of resources is automatically executed”. Furthermore, for the air conditioning facility, a prompt such as “Propose a cooling efficiency improvement measure based on a temperature transition of an air conditioning facility and outside air temperature data” is given, and the AI outputs a specific operation proposal such as “Since the cooling efficiency of air conditioning facility D has decreased, filter cleaning and a change in operation mode are recommended”. Specifically, the facility optimization unit extracts the resource usage history for the past one month as a time-series numerical vector. The facility optimization unit converts information of the business calendar as a one-hot encoded categorical vector. The facility optimization unit combines these vectors, and inputs them to a time-series prediction model of the generative AI. The time-series prediction model is an ensemble learning model combining an autoregressive integrated moving average model and a long short-term memory network. The time-series prediction model separates and learns seasonality, a trend, and a residual component from the input data. The time-series prediction model outputs demand predicted values of a CPU and a memory in each time zone for one week in the future as a tensor of floating-point numbers. The facility optimization unit inputs the tensor of the demand predicted values to a resource provisioning engine. The resource provisioning engine issues an API call to automatically start a necessary number of virtual machine instances 30 minutes before a predicted demand peak. The resource provisioning engine specifies a virtual machine with a low operating rate and executes a script to safely shut it down in a night time zone when demand decreases. Furthermore, the facility optimization unit integrates temperature sensor data of the air conditioning facility and outside air temperature data acquired from an external meteorological data API, and inputs them to a thermal fluid simulation model. The thermal fluid simulation model calculates a temperature distribution in the data center as three-dimensional voxel data. The facility optimization unit inputs the voxel data to the generative AI, and causes the generative AI to calculate an optimal air conditioning setting parameter for maximizing cooling efficiency. The generative AI outputs a control command to increase the number of rotations of an air conditioning fan in a corresponding area in order to eliminate a hot spot around a specific rack. With this configuration, the system integrally controls IT resources and facility resources. This integrated control exerts a technical effect of dramatically improving a power usage effectiveness index and minimizing operation costs. This technical effect is realized by a cooperation mechanism of multimodal predictive modeling integrating data of heterogeneous domains and physical simulation. The system applies the optimization mechanism to a specific use case of autonomous operation of an edge data center.

In the maintenance planning unit, for example, prompts such as “Analyze a failure occurrence history and a resource usage tendency of a server group, and output a priority of next preventive maintenance in natural language” and “Analyze an increase in I/O delay and disk life data of a storage device, and output a recommended replacement time” are given to the generative AI, and the AI automatically generates a maintenance plan such as “Since the memory usage rate of server B remains high and matches a past failure pattern, preventive maintenance should be preferentially executed” and “Since the I/O delay of storage device C is on an increasing trend, replacement within two weeks is recommended in view of the disk life data”. Specifically, the maintenance planning unit collects a frequency distribution of error codes extracted from a system log of the server group, and a physical deterioration index of a storage acquired from a SMART attribute. The maintenance planning unit normalizes these data, and calculates a multidimensional health score vector indicating a health state of each component. The maintenance planning unit inputs the health score vector to an abnormality detection autoencoder of the generative AI. The autoencoder is pre-trained using only data at a normal time. The autoencoder compresses the input health score vector into a low-dimensional latent space, and restores it to the original dimension again. The maintenance planning unit calculates a reconstruction error between the input vector and the restored vector. When the reconstruction error exceeds a predetermined threshold value, the maintenance planning unit determines that the corresponding component has fallen into an unknown deterioration mode. The maintenance planning unit collates the determination result with a knowledge base obtained by vectorizing past failure cases using cosine similarity. By this collation processing, the maintenance planning unit specifies a past failure case most similar to the current deterioration pattern. The maintenance planning unit inputs a resolution procedure of the specified failure case to a language model of the generative AI, and causes the language model to generate a maintenance plan text in which parameters are adjusted so as to conform to the current system environment. The maintenance plan text includes a physical slot number of a disk requiring replacement, a RAID rebuild command for data migration, and a scheduled work date and time. The maintenance planning unit registers the maintenance plan text in a maintenance management database, and automatically issues a related work ticket. With this configuration, the system realizes condition-based maintenance based on an actual deterioration state, rather than simple life-based replacement. This condition-based maintenance exerts a technical effect of avoiding a fatal system failure while preventing excessive replacement of parts. This technical effect is brought about by unsupervised abnormality detection by an autoencoder and a mechanism of extracting a similar case by vector search. The system applies the maintenance planning mechanism to a specific use case of availability management of a large-scale storage area network.

Furthermore, regarding the network device, a prompt such as “Propose a future peak time countermeasure from a fluctuation pattern of network traffic for the past one week” is given, and the AI outputs an operation proposal such as “Since the traffic of network device B exceeds 95 percent in a specific time zone, a scheduling change of a backup job and optimization of a traffic route are recommended”. Specifically, the facility optimization unit acquires sampling data of a packet header from an sFlow or NetFlow protocol of a network switch. The facility optimization unit analyzes the sampling data, and constructs a multidimensional tensor of a traffic flow including a source IP, a destination IP, a port number, and a protocol type. The facility optimization unit inputs the multidimensional tensor to a graph convolutional network of the generative AI. The graph convolutional network models a network topology as a graph structure of nodes and edges. The graph convolutional network learns a temporal change in a traffic volume on each edge, and predicts an occurrence probability of future traffic congestion. The generative AI calculates an optimal routing route for avoiding a predicted congestion point. This calculation is executed using Dijkstra's algorithm or a reinforcement learning-based route search algorithm. The generative AI generates a routing table update command of BGP or OSPF for realizing the calculated optimal route. Furthermore, the generative AI specifies a backup job occupying most of the traffic, and generates a proposal text for shifting an execution schedule of the job to a time zone in which a network band has a margin. The facility optimization unit transmits the update command to a controller of a software-defined network, and dynamically changes a setting of the network device. With this configuration, the system overcomes a limit of static bandwidth allocation, and realizes adaptive network control that follows a dynamic fluctuation of traffic. This adaptive control exerts a technical effect of minimizing packet loss and reducing end-to-end communication delay. This technical effect is achieved by an integrated mechanism of recognition of a spatial traffic pattern by a graph neural network and programmable route control by a software-defined network. The system applies the network optimization mechanism to a specific use case of slicing control of a 5G mobile core network.

Also, regarding the security facility, a prompt such as “Analyze an access log and an authentication history from 0:00 today to the present, extract an access pattern different from normal and suspicious behavior, and evaluate a threat level” is given, and the AI automatically generates a specific countermeasure such as “Since a large number of authentication failures have occurred from a specific terminal in a midnight time zone and suspicious communication to the outside has been observed, there is a high suspicion of a brute-force attack and malware infection. Network isolation of the corresponding terminal and temporary suspension of an account are recommended”. Specifically, the security monitoring unit collects raw log data output from a firewall, an intrusion detection system, and an active directory. The security monitoring unit extracts a timestamp, a user ID, a source IP address, an access destination resource, and a status code of an authentication result from the log data. The security monitoring unit tokenizes the extracted data in accordance with an input format of a natural language processing model, and converts the tokenized data into sequence data. The security monitoring unit inputs the sequence data to an abnormality detection transformer model of the generative AI. The abnormality detection transformer model pre-learns a behavior profile of a normal user. The abnormality detection transformer model calculates an abnormality score indicating how much the input sequence data deviates from the normal profile. For example, the model detects a pattern in which authentication failures using different user IDs from the same source IP address continue in a short time, and assigns a high abnormality score. The generative AI classifies a type of attack as a brute-force attack when the abnormality score exceeds a threshold value. Based on a classification result, the generative AI generates an update command of an access control list for blocking communication from the corresponding IP address, and an API call of a directory service for locking the corresponding user account. The security monitoring unit transmits these commands to a security orchestration, automation, and response platform, and causes the platform to immediately execute the commands. With this configuration, the system detects and blocks, in real time, an unknown attack method that cannot be handled by signature-based detection, and a subtle behavior change due to an internal crime. This real-time blocking exerts a technical effect of minimizing a risk of information leakage and protecting confidentiality of the system. This technical effect is brought about by a cooperation mechanism of context-dependent behavior analysis using a self-attention mechanism and an automated response pipeline. The system applies the security monitoring mechanism to a specific use case of defense of a confidential information management system of a government agency.

In this way, each unit cooperates to highly automate state monitoring, abnormality detection, failure cause estimation, resource optimization, energy management, preventive maintenance planning, security enhancement, failure response automation, and the like of various infrastructure devices such as servers, network devices, storage devices, air conditioning facilities, power supply facilities, and security facilities by utilizing generative AI, thereby making it possible to dramatically improve the safety, efficiency, and flexibility of the entire data center while significantly reducing the burden on the administrator. Specifically, the present system includes a central orchestration engine that integrates all of these subsystems. The central orchestration engine aggregates state vectors, abnormality scores, and optimization proposals asynchronously transmitted from each unit into a global state tensor on a shared memory. The central orchestration engine inputs the global state tensor to a top-level meta-generative AI model. The meta-generative AI model evaluates a side effect that optimization of an individual subsystem has on other subsystems. For example, the meta-generative AI model calculates a power reduction effect due to server consolidation and a risk of occurrence of a local heat pool associated therewith as a trade-off. The meta-generative AI model determines a global control policy that maximizes a utility function of the entire data center based on a concept of Pareto optimum. The central orchestration engine decomposes the determined global control policy into local parameter sets executable by each subsystem, and distributes the local parameter sets to each unit. Each unit autonomously controls hardware in its respective assigned area in accordance with the received parameter sets. With this configuration, the present system breaks through limitations of siloed individual management tools, and causes the data center to function as one huge autonomous computer. This autonomous function exerts a technical effect of completely eliminating manual intervention by a human operator and bringing system failures due to operational errors close to zero. This technical effect is realized by distributed cooperative inference by a plurality of hierarchized AI models and a global state synchronization mechanism. The present system applies this integrated architecture to an ultimate use case of fully autonomous operation of an unmanned dark data center. By this application, the present system establishes a foundation of a next-generation IT infrastructure.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

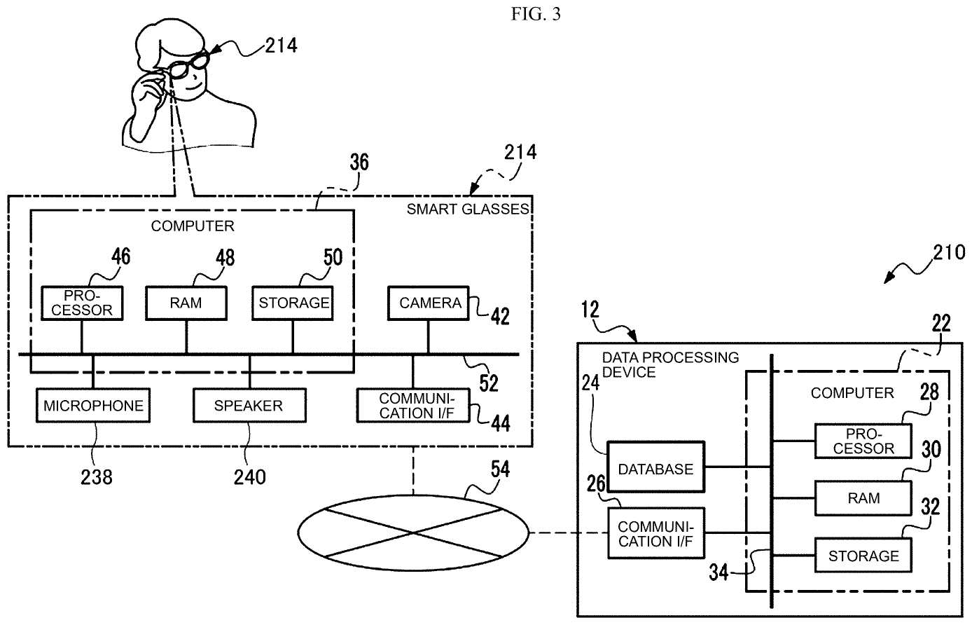

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

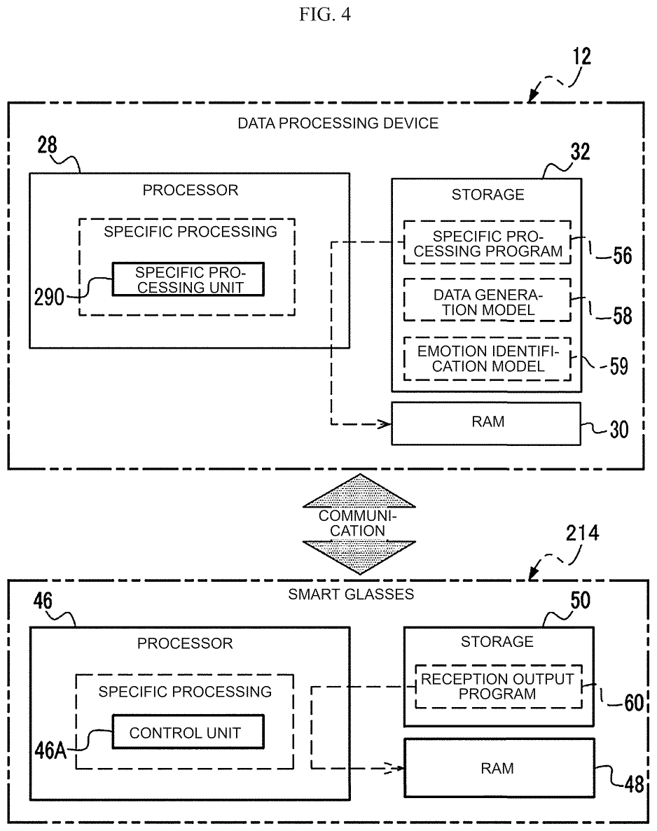

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

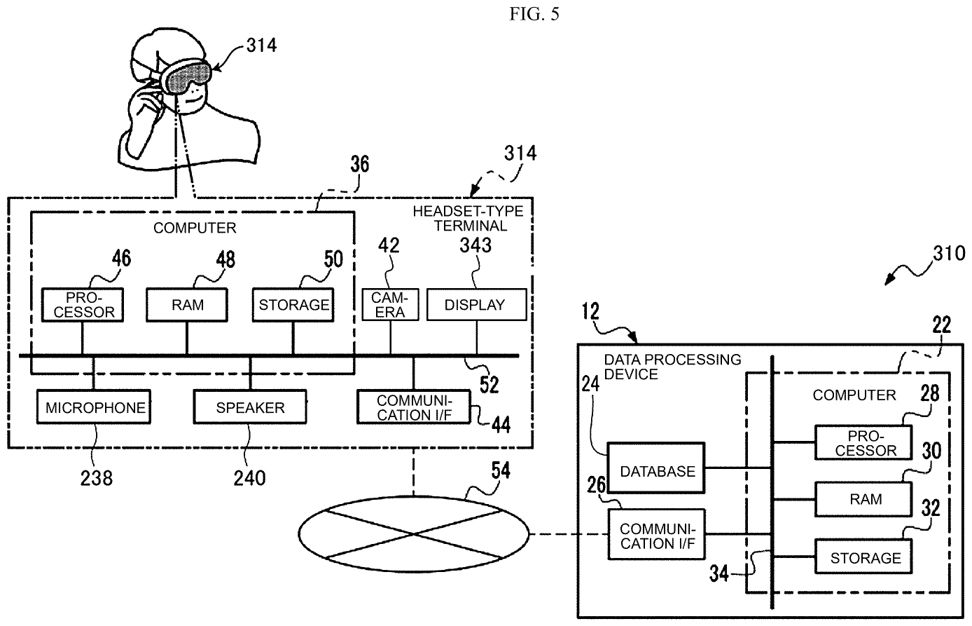

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

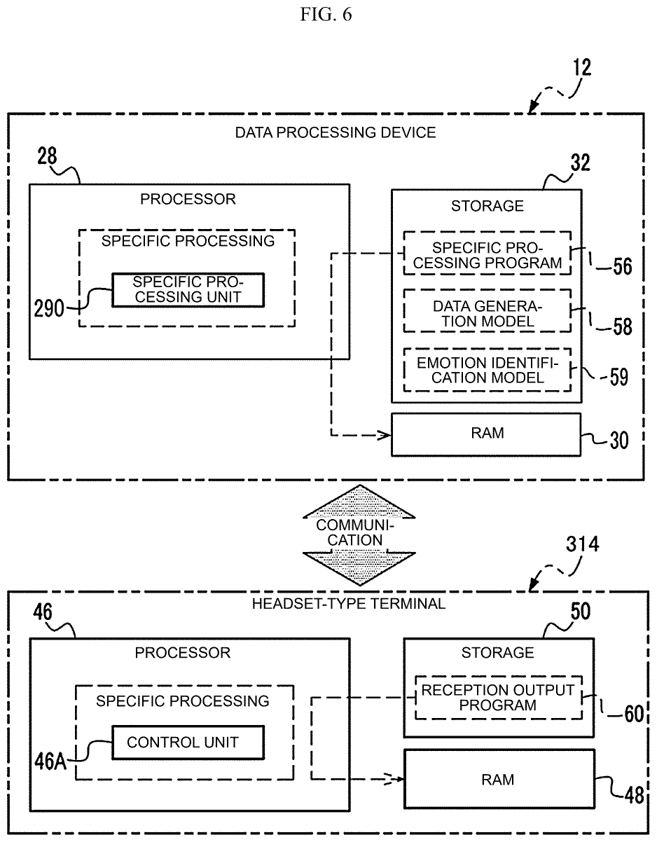

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

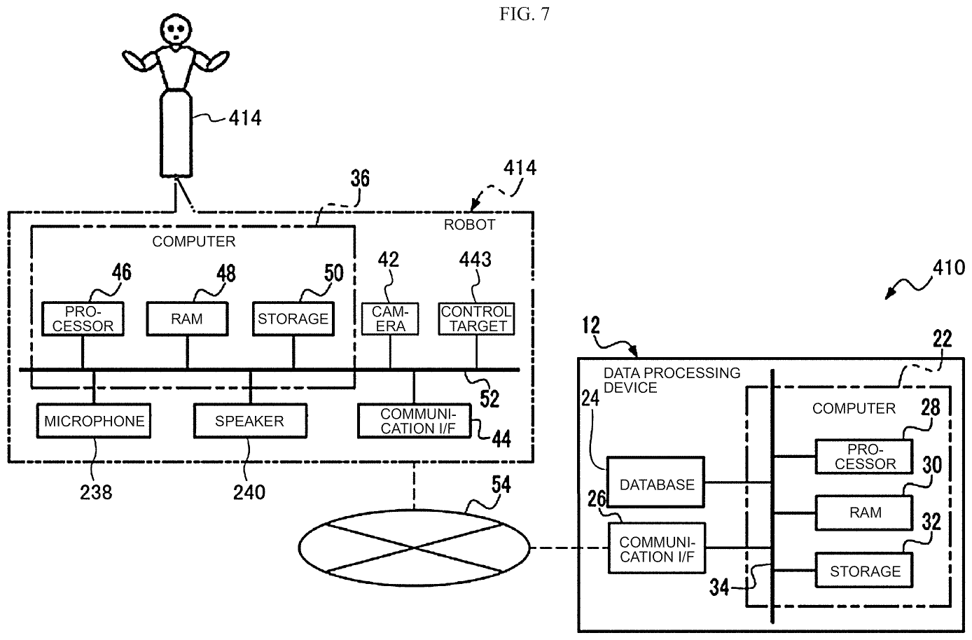

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

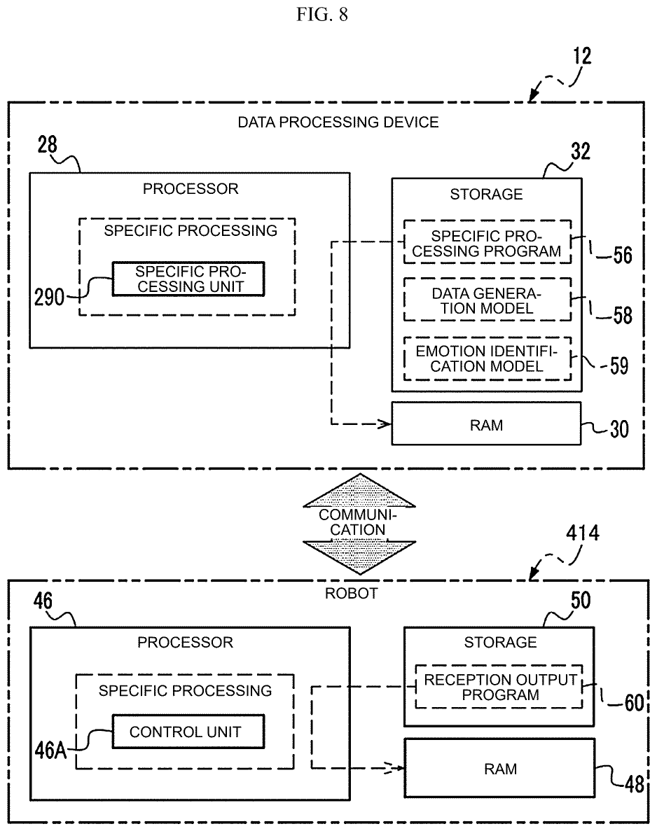

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

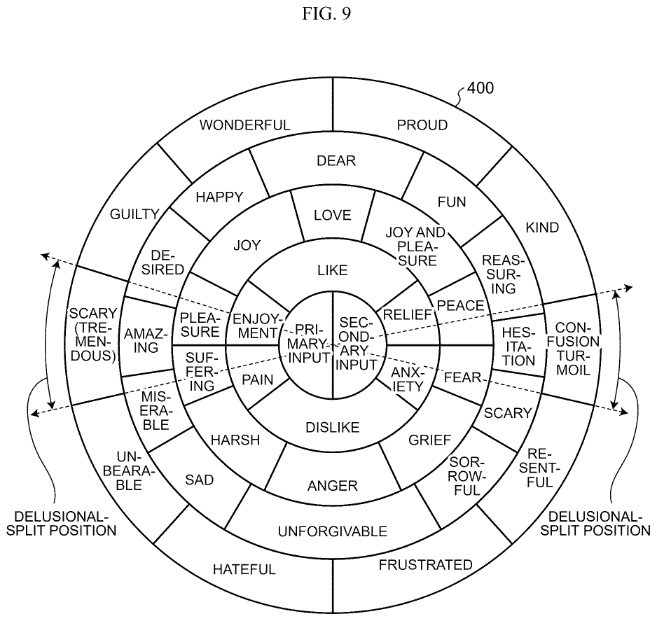

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

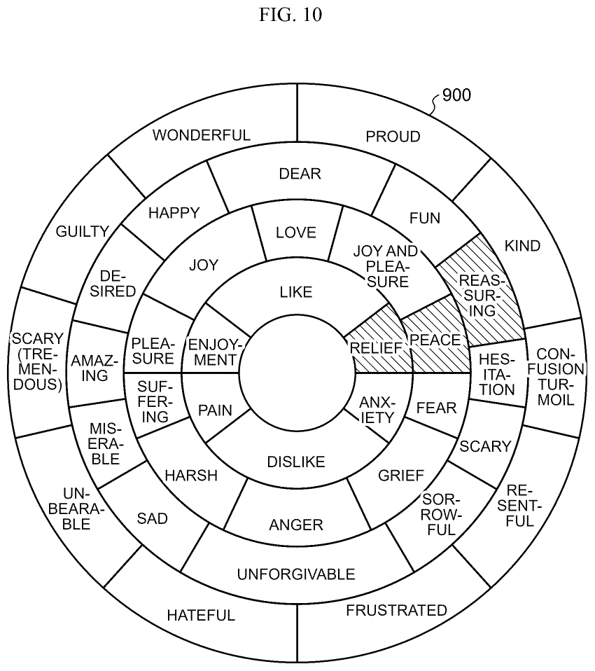

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A data center management system comprising: a server monitoring unit; a facility optimization unit; and a maintenance planning unit, wherein the server monitoring unit has a function of collecting an operating status, a resource usage rate, failure occurrence information, temperature, power consumption, a traffic volume, unauthorized intrusion detection information, and the like in real time from various infrastructure devices in a data center, such as a plurality of servers, network devices, power supply facilities, air conditioning facilities, storage devices, and security facilities, analyzing these data using generative AI, performing abnormality detection, failure sign analysis, early discovery of resource tightness, and automatic detection of security risks, and immediately generating an alert and notifying an administrator terminal of the alert when an abnormality or a high load is detected; the facility optimization unit has a function of analyzing operation data and past history data of a server group, network devices, air conditioning facilities, power supply facilities, and the like using generative AI, making an optimization proposal or performing automatic execution of load balancing of servers, automatic expansion and reduction of virtual servers, cooling enhancement of air conditioning facilities, automatic switching to a power saving mode, route optimization of network traffic, energy cost reduction measures, and the like, and presenting a result thereof to the administrator terminal; and the maintenance planning unit has a function of analyzing an operating status, a history of occurrence of an abnormality, a resource usage tendency, failure sign data, and the like of each facility using generative AI, automatically planning and executing prioritization of preventive maintenance and inspection, automatic generation of a maintenance schedule, facility life prediction, notification to maintenance personnel, and the like, and presenting maintenance plan contents to the administrator terminal.

### Supplementary Note 2

The data center management system according to Supplementary Note 1, further comprising a function of automatically generating a cause analysis thereof, identification of an affected range, and a recommended countermeasure when a failure occurs, based on an operating status of various facilities and an abnormality detection result collected by the server monitoring unit using generative AI, and presenting the cause analysis, the identification of the affected range, and the recommended countermeasure as a detailed report to the administrator terminal.

### Supplementary Note 3

The data center management system according to Supplementary Note 1, further comprising a function of causing the facility optimization unit to analyze a resource usage history, an energy consumption history, external environment data, future usage prediction data, and the like of the entire data center using generative AI, optimize resource allocation and an operation mode of servers, network devices, air conditioning facilities, power supply facilities, and the like in advance according to a predicted load fluctuation, a failure risk, and an energy cost fluctuation, and visualize and present an optimization result and a basis thereof to the administrator terminal.

What is claimed is:

1. A system comprising:
circuitry configured to:
receive, via a communication interface coupled to a packet-switched network, a multidimensional time-series tensor from sensor devices distributed across IT infrastructure components, and store the multidimensional time-series tensor in a storage device;
construct a digital twin environment of the IT infrastructure by integrating the multidimensional time-series tensor with three-dimensional coordinate data of a spatial model, and apply a deep learning model to the integrated data to generate a temperature distribution heat map and a resource utilization prediction matrix;
apply an autoencoder anomaly detection model to the multidimensional time-series tensor to compute reconstruction error scores, detect anomaly signals when reconstruction error scores exceed anomaly threshold parameters, and classify detected anomaly signals using a multi-class classification model to generate anomaly type identifiers;
analyze access log data and network communication data using a generative neural network model to detect threat indicator patterns, generate threat classification records, and automatically generate access blocking commands and isolation commands for confirmed threat indicators; and
transmit alert data records, resource optimization recommendations, and threat response records to terminal devices via the communication interface.

2. The system according to claim 1, wherein the circuitry is configured to receive the multidimensional time-series tensor comprising temperature values, power consumption values, network throughput values, and storage utilization values from sensor devices at a predetermined collection interval, apply a preprocessing pipeline comprising normalization and missing value interpolation to the received tensor, and update the digital twin environment state with the preprocessed tensor.

3. The system according to claim 2, wherein the circuitry is configured to compute a temperature distribution heat map by applying a spatial interpolation algorithm to temperature sensor values and three-dimensional coordinate data, and generate a resource utilization prediction matrix by applying a transformer-based time-series model to the multidimensional time-series tensor to compute multi-step ahead prediction values.

4. The system according to claim 3, wherein the circuitry is configured to apply the resource utilization prediction matrix to dynamically adjust operating parameters of facility control systems by transmitting control command data specifying updated airflow volume values and cooling water temperature values to facility control interfaces via the communication interface.

5. The system according to claim 1, wherein the circuitry is configured to apply a graph neural network to a network topology graph of the IT infrastructure comprising device nodes and communication link edges, execute message passing operations between adjacent nodes to propagate state update vectors, and generate a network state representation for use in anomaly detection and threat analysis.

6. The system according to claim 5, wherein the circuitry is configured to detect anomalous network state patterns by comparing current network state representation vectors against historical baseline network state vectors using cosine similarity, generate a network anomaly signal when the cosine similarity score falls below a network anomaly threshold parameter, and incorporate the network anomaly signal into the threat classification process.

7. The system according to claim 1, wherein the circuitry is configured to apply the autoencoder anomaly detection model to access log data by computing reconstruction error scores between input access log feature vectors and autoencoder output vectors, and apply a sequence classification model to access log time-series sequences to distinguish between normal behavioral patterns and unauthorized access patterns.

8. The system according to claim 7, wherein the circuitry is configured to generate the access blocking commands and isolation commands by applying the generative neural network model to the threat classification record and current network topology data, transmit the commands to network control interfaces via the communication interface, and store the execution record in a threat response audit log in the storage device.

9. The system according to claim 1, wherein the circuitry is configured to apply a predictive maintenance model to the multidimensional time-series tensor by computing degradation trend metrics for each infrastructure component using a one-dimensional convolutional neural network and a long short-term memory network, and generate a preventive maintenance schedule data record when a predicted degradation trend metric exceeds a maintenance threshold parameter.

10. The system according to claim 9, wherein the circuitry is configured to generate the preventive maintenance schedule data record comprising the affected infrastructure component identifier, a recommended maintenance action sequence, and a recommended maintenance timing parameter, and transmit the preventive maintenance schedule data record to terminal devices associated with maintenance personnel user identifiers.

11. The system according to claim 1, wherein the circuitry is configured to monitor resource utilization metrics from the resource utilization prediction matrix, automatically execute a scale-out command to provision additional virtual machine instances when a predicted utilization value exceeds a high-load threshold parameter, and generate a scale-in recommendation when a predicted utilization value falls below a low-load threshold parameter for a configurable time window.

12. The system according to claim 11, wherein the circuitry is configured to apply the generative neural network model to historical resource utilization records and predicted future workload patterns to compute an optimal resource configuration recommendation, and transmit the recommendation to terminal devices associated with administrative user identifiers for confirmation before executing scale-in operations.

13. The system according to claim 1, wherein the circuitry is configured to apply an energy optimization model to the temperature distribution heat map and resource utilization prediction matrix to generate energy consumption reduction recommendations comprising equipment power-state adjustment sequences and cooling system parameter modifications, and compute a projected energy consumption reduction metric for each recommendation.

14. The system according to claim 1, wherein the circuitry is configured to generate a unified dashboard data record from the digital twin environment state, anomaly detection results, threat classification records, and resource optimization recommendations, and transmit push notification data to terminal devices when a key metric crosses a configurable alert threshold.

15. The system according to claim 1, wherein the circuitry is configured to update the deep learning model and the autoencoder anomaly detection model by generating training pairs from historical sensor tensor records and corresponding validated anomaly labels, and fine-tune the models to reduce prediction error and improve anomaly detection accuracy.

16. The system according to claim 1, wherein the circuitry is configured to encrypt data transmissions between IT infrastructure sensor devices and the system using a transport layer security protocol, and apply a token-based authorization check for all incoming requests to modify access blocking commands or isolation commands.

17. The system according to claim 1, wherein the IT infrastructure components comprise servers, network devices, storage devices, and facility control systems, the digital twin environment models physical and logical states of the IT infrastructure, and the resource optimization recommendations correspond to virtual server scaling parameters and facility control parameter adjustments.

18. A system comprising:
circuitry configured to:
receive, via a communication interface coupled to a packet-switched network, a multidimensional time-series tensor from sensor devices across IT infrastructure components, and construct a digital twin environment by integrating the tensor with three-dimensional spatial model data;
apply a deep learning model to generate a temperature distribution heat map and a resource utilization prediction matrix, and apply a transformer-based time-series model for multi-step ahead resource utilization prediction;
apply an autoencoder anomaly detection model and a graph neural network to detect infrastructure anomalies and network state deviations, and apply a generative neural network model to access log data to detect threat indicator patterns and generate access blocking commands;
apply a predictive maintenance model using a convolutional neural network and long short-term memory network to generate preventive maintenance schedule data records; and
transmit alert data records, resource optimization recommendations, and threat response records to terminal devices via the communication interface.

19. The system according to claim 18, wherein the circuitry is configured to automatically execute scale-out commands when predicted resource utilization exceeds a high-load threshold and generate scale-in recommendations below a low-load threshold, apply an energy optimization model to generate consumption reduction recommendations, and update the deep learning model and autoencoder anomaly detection model by fine-tuning on historical sensor tensor records and validated anomaly labels.

20. A method comprising:
receiving, via a communication interface coupled to a packet-switched network, a multidimensional time-series tensor from sensor devices distributed across IT infrastructure components, and storing the multidimensional time-series tensor in a storage device;
constructing a digital twin environment by integrating the multidimensional time-series tensor with three-dimensional coordinate data, and applying a deep learning model to generate a temperature distribution heat map and a resource utilization prediction matrix;
applying an autoencoder anomaly detection model to compute reconstruction error scores and detect anomaly signals, and applying a generative neural network model to access log data to detect threat indicator patterns;
generating access blocking commands and isolation commands for confirmed threat indicators, and transmitting threat response records to network control interfaces; and
transmitting alert data records, resource optimization recommendations, and threat response records to terminal devices via the communication interface.
